(19) United States
(12) Patent Application Publication
(10) Pub. No.: US 2026/0015826 A1
(43) Pub. Date: Jan. 15, 2026

(54) Systems and Methods for Hydraulic Ride Control

(71) Applicant: HUSCO International, Inc., Waukesha, WI (US)

(72) Inventor: Gary J. Pieper, Waukesha, WI (US)

(21) Appl. No.: 19/330,621

(22) Filed: Sep. 16, 2025

Related U.S. Application Data
(63) Continuation-in-part of application No. 18/212,060, filed on Jun. 20, 2023.
(60) Provisional application No. 63/353,282, filed on Jun. 17, 2022.

(51) Int. Cl. E02F 9/22; E02F 9/26; F15B 1/04; F15B 13/02

(52) U.S. Cl. CPC E02F 9/2207; E02F 9/2217; E02F 9/26; F15B 1/04; F15B 13/027; E02F 9/2296; F15B 2211/526

(57) ABSTRACT

A ride control valve includes a valve body defining a work passage, a pump passage, a tank passage, and an accumulator passage configure to couple to an accumulator. A ride control spool is movably disposed within the valve body and configured to move between a first ride control position to discharge the accumulator, a second ride control position configured to charge the accumulator at a variable charge rate, a third ride control configured to balance the accumulator pressure with the work passage pressure, and a fourth ride control position configured to couple the accumulator to the work passage. A pressure balancing spool is movably disposed within the ride control spool to selectively couple the accumulator passage with each of the pump passage and the tank passage to balance the accumulator pressure. The ride control valve is configured to couple to a directional control valve without external conduit.

### CROSS-REFERENCES TO RELATED APPLICATIONS

This application is a continuation-in-part of U.S. patent application Ser. No. 18/212,060, filed on Jun. 20, 2023, which claims priority to and the benefit of U.S. Provisional Patent Application No. 63/353,282, filed on Jun. 17, 2022, each of which is incorporated herein by reference in its entirety.

### BACKGROUND

Hydraulic systems can be used as suspensions for hydraulic machines. In particular, ride control systems can be configured to dampen movement of a boom, lift arm, etc. of a hydraulic machine as it traverses over a support surface.

### BRIEF SUMMARY

According to one aspect of the disclosure, a ride control system is provided for a hydraulic machine having a pump, an actuator, and a tank. The ride control system can include an accumulator and a control valve having a work port configured to couple to the actuator, a pump port configured to couple to the pump, and a tank port configured to couple the tank, and an accumulator port configured to couple to the accumulator. The control valve can include a directional control valve and a ride control valve. The directional control valve can be configured to selectively couple the work port, the pump port, and the tank port to operate the actuator. The ride control valve can include a valve body. A ride control spool can be movably disposed within the valve body and configured to selectively couple the work port, the tank port, the pump port, and the accumulator. A pressure balancing spool can be movably disposed within the valve body and configured to selectively couple the accumulator with the pump port and the tank port. The ride control spool can be configured to move between each of: a first ride control position configured to couple the accumulator with the tank port to discharge the accumulator; a second ride control position configured to couple the pump port to the accumulator to charge the accumulator; a third ride control position configured to balance an accumulator pressure of the accumulator with a work port pressure of the work port; and a fourth ride control position configured to couple the accumulator to the work port.

In some non-limiting examples, the second ride control position can be an infinitely variable position, in which the ride control spool moves between the first ride control position and the third ride control position to vary a charging flow rate of the accumulator.

In some non-limiting examples, the pressure balancing spool can be movable between each of: a neutral position configured to decouple the accumulator from both the tank port and the pump port; a first balancing position configured to decouple the accumulator from the pump port and to couple the accumulator to the tank port to discharge the accumulator; and a second balancing position configured to decouple the accumulator from the tank port and to couple the accumulator to the pump port to charge the accumulator. The pressure balancing spool can include a biasing assembly configured to bias the pressure balancing spool into the neutral position when a difference between the work port pressure and the accumulator pressure is within a predetermined pressure differential. The pressure balancing spool can be biased to the first balancing position when the accumulator pressure is greater than the work port pressure by at least the predetermined pressure differential. The pressure balancing spool can be biased to the second balancing position when the work port pressure is greater than the accumulator pressure by at least the predetermined pressure differential.

In some non-limiting examples, the ride control valve can further include a first electrohydraulic pressure regulating valve configured to move the ride control spool from the first ride control position to each of the second ride control position, the third ride control position, and the fourth ride control position. A controller can be configured to energize the first electrohydraulic pressure regulating valve to move the ride control spool. The controller can be configured to energize the first electrohydraulic pressure regulating valve to move the ride control spool from the third ride control position to the fourth ride control position when a pressure difference between the work port pressure and the accumulator pressure is within a predetermined pressure differential. The controller can be configured to determine the pressure difference between the work port pressure and the accumulator pressure based on a first sensor configured to measure the work port pressure and a second sensor configured to measure the accumulator pressure. In some cases, the ride control spool can be further configured to move to a fifth ride control position configured to couple the pump port directly to the tank port. The ride control valve can include a second electrohydraulic pressure regulating valve configured to move the ride control spool from the first ride control position to the fifth ride control position.

In some non-limiting examples, the ride control valve can further include a pressure relief valve configured to limit the accumulator pressure to a maximum accumulator pressure. In some non-limiting examples, the control valve can further include a low leak check valve configured to selectively couple the work port to the accumulator. The ride control valve can include a control passage coupled to a control chamber of the low leak check valve. The control passage can be coupled to a port of the low leak check valve via the ride control spool when the ride control spool is in the fourth ride control position. The ride control spool includes a check valve between the control passage and the control chamber to inhibit flow from the ride control spool to the low leak check valve control chamber.

In some non-limiting examples, the control valve can be configured as a sectional valve that can include a first valve section with the directional control valve and a second valve section with the ride control valve. The first valve section and the second valve section can be directly coupled to one another. In some non-limiting examples, the control valve can be configured as a monoblock valve that can include both the directional control valve and the ride control valve.

In some non-limiting examples, the valve body of the ride control valve can define a plurality of passages, which can include a work passage coupled to the work port, a tank passage coupled to the tank port, an accumulator passage coupled to the accumulator, and a pump passage coupled to the pump port.

According to one aspect of the disclosure, a ride control valve is provided. The ride control valve can include a valve body defining a work passage, a pump passage, a tank passage, and an accumulator passage. A ride control spool can be movably disposed within the valve body and configured to move between: a first ride control position that blocks the work passage and the pump passage, and couples the accumulator passage with the tank passage; a second ride control position that blocks the tank passage and the work passage, and couples the pump passage to the accumulator passage; a third ride control position that blocks the work passage and configured to selectively couple the accumulator passage with each of the pump passage and the tank passage; and a fourth ride control position that blocks the pump passage and the tank passage, and couples the accumulator passage with the work passage. A pressure balancing spool can be movably disposed within the ride control spool. The pressure balancing spool can be configured to move relative to the ride control spool to selectively couple the accumulator passage with each of the pump passage and the tank passage.

In some non-limiting examples, the pressure balancing spool can be configured to move relative to the ride control spool between a neutral position that blocks the pump passage, the accumulator passage, and the tank passage; a first balancing position that blocks the work passage and couples the accumulator passage to the tank passage; and a second balancing position that blocks the tank passage and couples the accumulator passage to the pump passage. The ride control valve can include a biasing assembly configured to bias the pressure balancing spool into the neutral position. In some cases, the biasing assembly can include a first balancing spring and a second balancing spring positioned on opposite ends of the pressure balancing spool to bias the pressure balancing spool to the neutral position when a pressure difference between a work passage pressure and an accumulator passage pressure is within a predetermined pressure differential. The pressure balancing spool can be biased to the first balancing position and can compress the first balancing spring when the accumulator passage pressure is greater than the work passage pressure by the predetermined pressure differential. The pressure balancing spool can be biased to the second balancing position and can compress the second balancing spring when the work passage pressure is greater than the accumulator passage pressure by the predetermined pressure differential.

In some non-limiting examples, the ride control valve can include a first control spring positioned between the ride control spool and a first spool seat, and a second control spring positioned between the first spool seat and a second spool seat defined by the valve body. In the first ride control position, the ride control spool can be at a first distance from the first spool seat and the first spool seat can be spaced from the second spool seat. In the second ride control position, the ride control spool can be at a second distance from the first spool seat and the first spool seat can be spaced from the second spool seat. In the third ride control position, the ride control spool can contact the first spool seat and the first spool seat can be spaced from the second spool seat. In the fourth ride control position, the ride control spool can contact the first spool seat and the first spool seat can contact the second spool seat.

In some non-limiting examples, the ride control valve can include an electrohydraulic pressure regulating valve that can be configured to move the ride control spool from the first ride control position to each of the second ride control position, the third ride control position, and the fourth ride control position. In some cases, the ride control spool can be configured to move to a fifth ride control position that blocks the work passage and the accumulator passage and couples the pump passage to the tank passage.

According to one aspect of the disclosure, a method for controlling a ride control valve for a hydraulic machine is provided. The method can include moving a ride control spool of a ride control valve between a plurality of ride control positions to selectively couple a work passage, a pump passage, a tank passage, and an accumulator passage. The plurality of ride control positions can include a first ride control position configured to couple the accumulator passage with the tank passage; a second ride control position configured to couple the pump passage to the accumulator passage; a third ride control position configured to balance an accumulator pressure of the accumulator passage with a work pressure of the work passage; and a fourth ride control position configured to couple the accumulator passage to the work passage. The second ride control position can be a variable position between the first ride control position and the third ride control position.

According to one aspect of the present disclosure, a ride control system for a hydraulic machine having a pump, an actuator, and a tank is provided. The ride control system includes an accumulator and a control valve having a work port configured to couple to the actuator, a pump port configured to couple to the pump, and a tank port configured to couple to the tank, and an accumulator port configured to couple to the accumulator. The control valve includes a directional control valve configured to selectively couple the work port, the pump port, and the tank port to operate the actuator. A ride control valve includes a valve body and a ride control spool movably disposed within the valve body, the ride control spool configured to selectively couple the work port, the tank port, the pump port, and the accumulator. A pressure balancing spool is movably disposed within the valve body and configured to selectively couple the accumulator with the pump port and the tank port. The ride control spool is configured to move between each of a first ride control position configured to couple the accumulator with the tank port to discharge the accumulator, a second ride control position configured to selectively couple the pump port to the accumulator to charge the accumulator, a third ride control position configured to selectively couple the tank port to the accumulator to balance an accumulator pressure of the accumulator with a work port pressure of the work port, a fourth ride control position configured to couple the accumulator to the work port, and a fifth ride control position configured to couple the accumulator with the pump port and the tank port to heat fluid in the hydraulic machine to an operating temperature.

In some non-limiting examples, the second ride control position is an infinitely variable position in which the ride control spool moves between the first ride control position and the third ride control position to vary a charging flow rate of the accumulator. In some non-limiting examples, when the ride control spool is in the second ride control position, the pressure balancing spool is movable between each of a first balancing position configured to couple the pump port to the accumulator to charge the accumulator, and a second balancing position configured to decouple the accumulator from the pump port. In some non-limiting examples, the pressure balancing spool includes a biasing assembly configured to bias the pressure balancing spool into the first balancing position when the accumulator pressure is less than a charge limit pressure defined by a charge limit relief valve. In some non-limiting examples, the pressure balancing spool is biased to the second balancing position when the accumulator pressure is greater than or equal to the charge limit pressure.

In some non-limiting examples, when the ride control spool is in the third ride control position, the pressure balancing spool is movable between each of a first balancing position configured to decouple the accumulator from the pump port and to couple the accumulator to the tank port to discharge the accumulator, and a second balancing position configured to decouple the accumulator from the tank port. In some non-limiting examples, the pressure balancing spool includes a biasing assembly configured to bias the pressure balancing spool into the first balancing position when the accumulator pressure is greater than the work port pressure by at least a first predetermined pressure differential. In some non-limiting examples, the pressure balancing spool is biased to the second balancing position when the work port pressure is greater than the accumulator pressure by at least a second predetermined pressure differential.

In some non-limiting examples, the ride control valve further includes a first electrohydraulic pressure regulating valve configured to move the ride control spool from the first ride control position to each of the second ride control position, the third ride control position, and the fourth ride control position. In some non-limiting examples, the ride control system further includes a controller configured to energize the first electrohydraulic pressure regulating valve to move the ride control spool. In some non-limiting examples, the controller is configured to energize the first electrohydraulic pressure regulating valve to move the ride control spool from the third ride control position to the fourth ride control position when a pressure difference between the work port pressure and the accumulator pressure is within a predetermined pressure differential. In some non-limiting examples, the controller is configured to determine the pressure difference between the work port pressure and the accumulator pressure based on a first sensor configured to measure the work port pressure and a second sensor configured to measure the accumulator pressure. In some non-limiting examples, the ride control valve includes a second electrohydraulic pressure regulating valve configured to move the ride control spool from the first ride control position to the fifth ride control position. In some non-limiting examples, the ride control valve further includes a pressure compensator spool and a check valve disposed within the compensator spool to prevent fluid flow from the accumulator to the pump port when the ride control valve is in the third ride control position. In some non-limiting examples, the control valve further includes a low leak check valve configured to selectively couple the work port to the accumulator and a check valve is configured to selectively inhibit flow from the ride control spool to a control chamber of the low leak check valve. In some non-limiting examples, the ride control valve includes a control passage coupled to the control chamber of the low leak check valve; and the control passage is coupled to a port of the low leak check valve via the ride control spool when the ride control spool is in the fourth ride control position. In some non-limiting examples, the check valve is configured to selectively inhibit flow from the accumulator to the control chamber of the low leak check valve when the ride control spool is in the fourth ride control position. In some non-limiting examples, the valve body of the ride control valve defines a plurality of passages including a work passage coupled to the work port, a tank passage coupled to the tank port, an accumulator passage coupled to the accumulator, and a pump passage coupled to the pump port.

### BRIEF DESCRIPTION OF THE DRAWINGS

The disclosure will be better understood, and features, aspects, and advantages will become apparent when consideration is given to the following detailed description thereof. Such detailed description references to the following drawings.

FIG. 1 is a schematic diagram of an example ride control system including a ride control valve, in accordance with some aspects of the disclosure.

FIG. 2 is a detail schematic diagram of the ride control valve of FIG. 1.

FIG. 3 is a cross-sectional view of the ride control valve of FIG. 1 in a first ride control configuration.

FIG. 4 is a detail schematic diagram of the ride control valve of FIG. 1 including a warm-up function, in accordance with some aspects of the disclosure.

FIG. 5 is a cross-sectional view of the ride control valve of FIG. 1 in a first ride control configuration.

FIG. 6 is a flowchart of a method for controlling a ride control system, according to aspects of the disclosure.

FIG. 7 is a plot showing an electrical command supplied by a controller to energize an electrohydraulic pressure regulating valve to operate a ride control valve between a plurality of ride control configurations.

FIG. 8 is a cross-sectional view of a spool of the ride control valve of FIG. 1 in a second ride control configuration.

FIG. 9 is a cross-sectional view of a spool of the ride control valve of FIG. 1 in a third ride control configuration.

FIG. 10 is a cross-sectional view of a spool of the ride control valve of FIG. 1 in a fourth ride control configuration.

FIG. 11 is a cross-sectional view of a spool of the ride control valve of FIG. 1 in a fifth ride control configuration.

FIG. 12 is a schematic diagram of another example ride control system including a ride control valve, in accordance with some aspects of the disclosure.

FIG. 13 is a cross-sectional view of the ride control valve of FIG. 12 in a first ride control position.

FIG. 14 is a cross-sectional view of the ride control valve of FIG. 12 in a second ride control position and of a balancing spool of the ride control valve in a first balancing position.

FIG. 15 is a cross-sectional view of the ride control valve of FIG. 12 in a second ride control position and of a balancing spool of the ride control valve in a second balancing position.

FIG. 16 is a cross-sectional view of the ride control valve of FIG. 12 in a third ride control position and of a balancing spool of the ride control valve in a first balancing position.

FIG. 17 is a cross-sectional view of the ride control valve of FIG. 12 in a third ride control position and of a balancing spool of the ride control valve in a second balancing position.

FIG. 18 is a cross-sectional view of the ride control valve of FIG. 12 in a fourth ride control position.

FIG. 19 is a cross-sectional view of the ride control valve of FIG. 12 in a fifth ride control position.

FIG. 20 is a plot showing an electrical command supplied by a controller to energize electrohydraulic pressure regulating valves to operate a ride control valve between a plurality of ride control positions, according to aspects of the disclosure.

FIG. 21 is a plot showing an electrical command supplied by a controller to energize electrohydraulic pressure regulating valves to operate a ride control valve between a plurality of ride control positions, including a warm-up position, according to aspects of the disclosure.

### DETAILED DESCRIPTION

Before any aspects of the present disclosure are explained in detail, it is to be understood that the present disclosure is not limited in its application to the details of construction and the arrangement of components set forth in the following description or illustrated in the following drawings. The present disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings and may also indicate fluid couplings.

The following discussion is presented to enable a person skilled in the art to make and use aspects of the present disclosure. Various modifications to the illustrated configurations will be readily apparent to those skilled in the art, and the generic principles herein can be applied to other configurations and applications without departing from aspects of the present disclosure. Thus, aspects of the present disclosure are not intended to be limited to configurations shown but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of the present disclosure. Skilled artisans will recognize the non-limiting examples provided herein have many useful alternatives and fall within the scope of the present disclosure.

The use of terms hydraulic machine or off-road vehicle includes but is not limited to tractors, forklifts, backhoes, wheel-loaders, excavators, and other any other type of vehicle that may be useful in construction, agriculture, and factory settings. Some hydraulic machines may not be equipped with suspensions at the wheel axles. The lack of wheel axle suspension can lead to unwanted bumps and vibrations transferred to the driver and/or load being carried by the hydraulic machine, as the machine traverses rough terrain. Similarly, even where traditional wheel suspensions are included, the varying loads capable of being supported by hydraulic machines, particularly when supported on a boom or lift arm, can also result in oscillations or other unwanted movement of the load as the hydraulic machine traverses over a support surface. Movement of the load with the boom of lift arm may transfer vibrations to the driver or may cause the hydraulic machine to lose a portion of the load it may be carrying.

Correspondingly, a hydraulic machine can include a hydraulic ride control system that can be used to dampen machine oscillations caused by heavy loads being supported by a boom, bucket, or other mechanism extending outward from a center of the vehicle while moving at transport speeds. The ride control system can allow the boom and a supported load to rest on a hydraulic accumulator, which may act as a “sponge” to absorb and suppress oscillations and other movements of the boom.

That is, the boom and supported load can be allowed to move up or down relative to a frame of the hydraulic machine, as the hydraulic machine moves and encounters bumps in the terrain. As the actuator of the boom, bucket, or other mechanism moves, it can cause an increase or decrease in hydraulic pressure, which in turn can cause a corresponding actuator to extend or retract to absorb the pressure fluctuations from the boom. The extension and retraction of the actuator causes fluid to flow into and out of the actuator to aid in the suppression of the hydraulic machine oscillations and the cushioning of the load. Correspondingly, the pressurized fluid for the actuator can be stored and received from an accumulator.

In some conventional implementations, a ride control system can be an optional feature that can be added after machine purchase or after delivery to a dealer. These ride control systems can be added by mounting a separate ride control valve assembly to the machine, and then making additional piping connections to various components of the system such as the load holding cylinder, tank, pump, load sense, and electrical control and wiring. Due to the multiple requirements and hydraulic connections of the ride control system, these connections often require separate hydraulic components, each requiring their own command signal (hydraulic or electrical). For example, such systems may utilize a plurality of solenoids to implement ride control functionality. A control system is then needed to measure system pressures and activate or deactivate the appropriate components to suppress machine oscillations upon the operator selection of ride control. Relatedly, such conventional ride control systems typically consume commanded flow from the actuator, or another source, which in some cases, may reduce operational power to the boom.

The present disclosure may provide improvements over conventional ride control system by providing a hydraulic ride control system that provide a means for charging an accumulator pressure, balancing the accumulator pressure with the hydraulic pressure caused by the hydraulic load with minimal effect on boom performance, activating ride control to suppress hydraulic machine oscillations while the machine moves, and heating the hydraulic fluid of the hydraulic system to a desired operating temperature. The ride control system controls charging of the hydraulic accumulator and makes the required connections with a load supporting actuator to provide a means for absorbing oscillations of a machine oscillator during transport mode. The system can be added to a compatible hydraulic control valve without any external piping connections to the hydraulic supply or actuator. More specifically, the system can be formed as a ride control valve section, which can be (directly) coupled to a directional control valve section for controlling boom operation, thereby forming a main control valve (e.g., a main valve block or main valve assembly). In a similar vein, the ride control valve can also be integrally formed within the directional control valve as a monoblock valve.

As a result, the connection (piping, fluid channels, etc.) between the ride control valve and the directional control valve can be internal to the main control valve, without the need for external conduits. Put another way the ride control connections can be fully contained within the main control valve assembly. Further, this can allow the ride control valve to be installed at a factory, by a dealer, or as an aftermarket system. Accordingly, ride control functionality can be added to or removed from a properly equipped main control valve assembly, without impacting the actuator pipework or plumbing hardware.

Relatedly, the system can be controlled through all modes of operation via current commands to one or more single proportional solenoid valves, and all the connections to and from the actuator and to and from the accumulator can be made with a single spool. Further, accumulator charging flow rate and maximum pressure can also be varied in the system, giving machine designers the ability to determine when and how much hydraulic pressure is applied to the ride control circuit. Specifically, the hydraulic connections to and from the actuator and to and from the accumulator can be made using a single control spool (i.e., a ride control spool), which also contains an internal spool (i.e., a pressure balancing spool) configured to balance the accumulator and actuator pressures. In this way, the system can allow the accumulator charging circuit to be shut off and can have a variable compensated flow input rate. In some cases, the ride control circuit can be used with low leak check valve hardware without affecting actuator leakage rates. The low leak check device can be located between the ride control system and the actuator. The low leak check device can be unlocked with the main ride control spool. The ride control accumulator can be discharged and consume no hydraulic power when switched off.

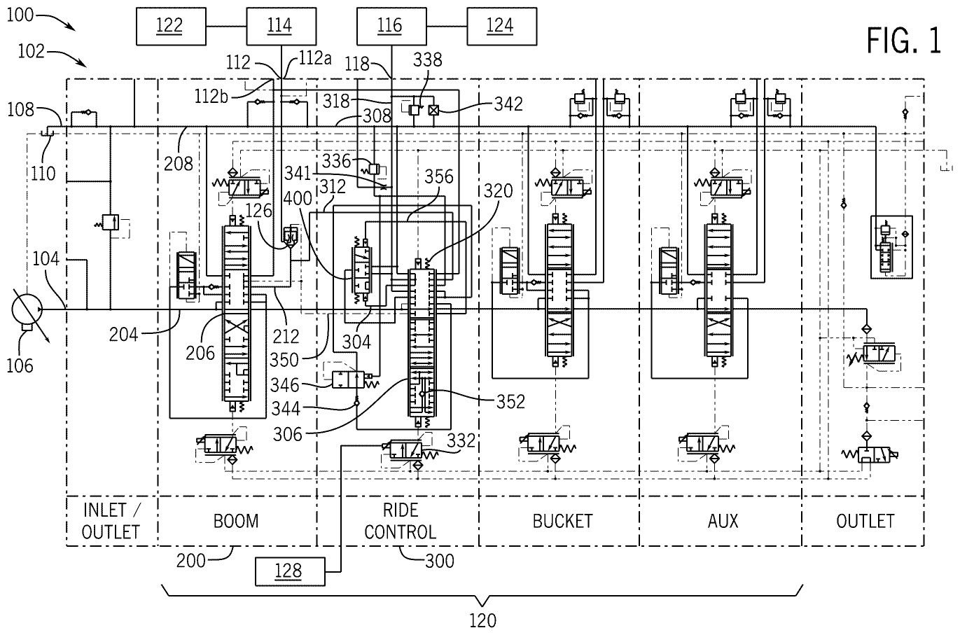

Referring to FIG. 1, as described above, hydraulic vehicles (not depicted), may include a ride control system 100 to provide dampening to vehicle functions such as booms, buckets, lift arms, or other implements or attachments as a hydraulic vehicle travels over uneven terrain or another support surface. In some configurations, a hydraulic vehicle may include a main control valve 102 for controlling the vehicle functions. To control the functions, the main control valve 102 (e.g., a valve body thereof) can generally include a pump port 104 configured to couple to a pump 106 of the hydraulic machine. The pump 106 can be a hydraulic pump configured to supply a flow of hydraulic fluid at desired pressure. More specifically, the pump 106 can be a variable displacement, or other type of pump configured to supply a flow of fluid at a desired pressure (e.g., a range of desired pressures). Additionally, the main control valve 102 can include a tank port 108 configured to couple to a tank 110 of the hydraulic machine, a work port 112 configured to couple to an actuator 114 of the hydraulic machine, and an accumulator port 118 configured to couple to an accumulator 116. For example, the actuator 114 can be configured to operate a boom, lift arm, or other function of the hydraulic machine. Accordingly, operation of the main control valve 102 can selectively couple the pump 106, the tank 110, and the actuator 114, by selectively coupling any of the pump port 104, the tank port 108 and the work port 112. In some cases, a main control valve can include more than one work port. For example, the main control valve 102 can include a first work port and a second work port for coupling to either end of a double-acting cylinder (e.g., the head and rod of a boom, respectively). Specifically, a first work port corresponding to a first end of a double-acting cylinder can be selectively coupled to the accumulator while a second work port corresponding to a second end of a double-acting cylinder can be selectively coupled to the tank.

Additionally, to provide a ride control function for the hydraulic machine, the main control valve 102 can be part of the ride control system 100, which can selectively couple the actuator 114 to the accumulator 116 via the accumulator port 118. Put another way, the main control valve 102 can be configured to selectively couple the accumulator port 118 to the actuator 114 to dampen pressure oscillations of the actuator 114 as the hydraulic machine moves along a support surface. As described in further detail below, the accumulator 116 can act as a shock absorber to attenuate pressure oscillation of the actuator 114 resulting from the hydraulic machine traveling along the ground. For example, when the ride control system is activated to couple the actuator 114 to the accumulator 116, an increase in actuator pressure can cause fluid to flow from the actuator 114 to be stored in the accumulator 116, while a decrease in pressure can cause fluid stored in the accumulator 116 to flow out to the actuator 114. In this way, the ride control system allows the boom inertia to be decoupled from the hydraulic machine, resulting in a smoother ride.

In some cases, a main control valve can be a single control valve (i.e., a single valve block) that can be installed on a hydraulic machine, as compared with conventional designs where multiple valve blocks are provided to control, for example; each of a boom function, a ride control function, and a warm-up function. As will become apparent in the discussion below, providing a ride control system as a single valve block with other machine functions (e.g., as a sectional valve or monoblock valve) can achieve numerous benefits over conventional systems, including, for example, increased operating efficiency and reducing the need for separate controllers and external conduits to connect and operate the ride control system with the various machine functions.

Correspondingly, as shown in the illustrated non-limiting example of FIG. 1, the main control valve 102 can be configured as a sectional control valve that may include one or more valve sections 120, which can be coupled with one another. The one or more valve sections 120 may each control a function of the hydraulic vehicle, such as a boom, a bucket, an auxiliary control, or a ride control system. With sectional control valves, each of the one or more valve sections 120 can be provided in separate valve bodies that may be selectively coupled with one another (e.g., to collectively form a valve body of the main control valve 102), according to the needs of a customer. That is, for example, a main control valve can be assembled at a factory to include a ride control section, or a ride control section can be installed by a dealer (e.g., as an aftermarket system). In other non-limiting examples, the main control valve 102 may be a mono-block valve, in which a function section and ride control section are provided within a single, monolithic valve body.

As described above, the main control valve 102 may include valve sections 120 to control various functions of the hydraulic machine. For example, the valve sections 120 may include a boom section 200 (e.g., a directional control valve) configured to operate the actuator 114, and a ride control section 300 (e.g., a ride control valve) configured to selectively couple the actuator 114 to the accumulator 116, which can be directly coupled to one another. That is, a valve body of the directional control valve can be directly mechanically coupled to a valve body of the ride control valve. In some configurations, the valve sections 120 may further include other types of function sections, such as a bucket section, an auxiliary function section, as well as additional function sections for other functions. In some configurations, each of the valve sections 120 may be configured with internal passages to couple to the pump 106, the tank 110, the actuator 114, and the accumulator 116 to perform their respective operations.

For example, still referring to FIG. 1, a directional control valve 200 may be configured to operate the actuator 114 (i.e., a boom cylinder). In this case, the actuator 114 is coupled to the work port 112, which is defined in the directional control valve 200. More specifically, the directional control valve 200 may be configured to operate the actuator 114 by controlling a flow of fluid to and from the actuator 114 to cause the actuator 114 to extend and retract in order to raise or lower a load. For example, hydraulic fluid supplied from the work port 112 to the actuator 114 may cause the actuator 114 to extend to raise a load, while hydraulic fluid leaving the actuator and entering the work port 112 may cause the actuator 114 to retract to lower the load. It is appreciated that the pressure of the hydraulic fluid can be adjusted in accordance with the load (e.g., the pressure can be increased as the load increases, and vice versa) to allow the load to be held at a particular height relative to the ground.

To operate the actuator 114, the directional control valve 200 may include a directional control spool 206 that may be movable between a plurality of positions and/or configurations. Movement of the directional control spool 206 between the plurality of positions and/or configurations can control fluid flow into, out of, or between one or more passages formed within the directional control valve 200. For example, the directional control valve 200 (e.g., a valve body thereof), can include a pump passage 204 to couple to the pump 106, a tank passage 208 to couple to the tank 110, and a work passage 212 to couple to the actuator 114. In some cases, and as will be described in greater detail below, the work passage 212 can be configured to couple the directional control valve 200 to a ride control valve 300, allowing the actuator 114 to be selectively coupled to the accumulator 116 to activate and deactivate the ride control system 100.

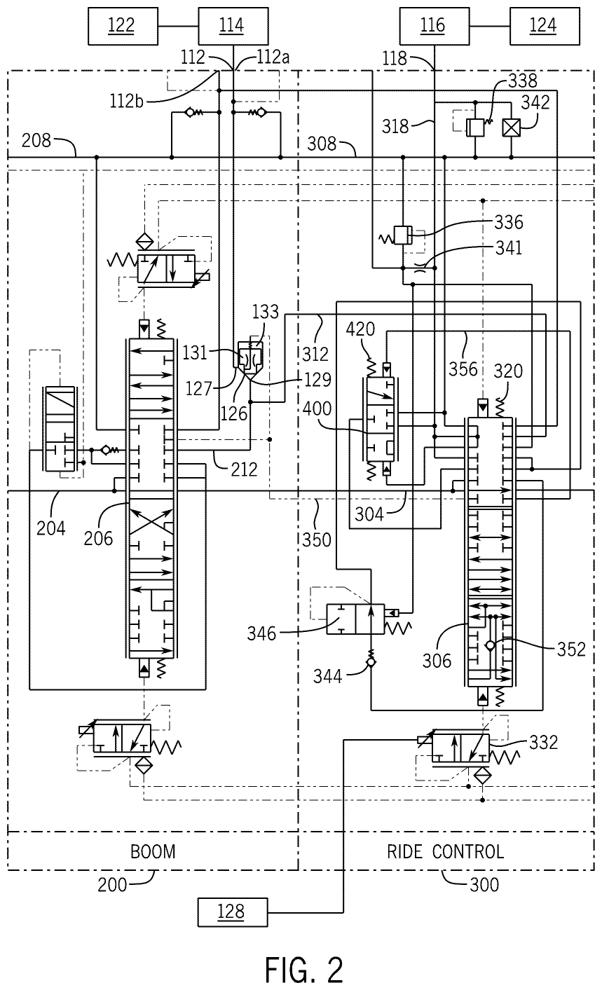

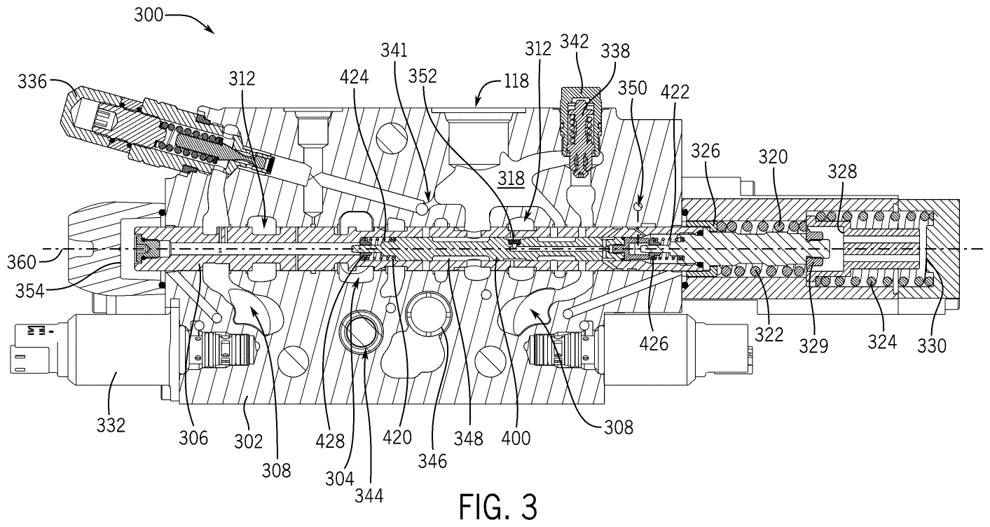

With additional reference to FIGS. 2 and 3, the main control valve 102 includes the ride control valve 300, which can be configured to activate and deactivate a ride control function of the hydraulic machine to serve as a suspension for the boom or other work function. Put another way, the ride control valve 300 can selectively couple the accumulator 116 to the actuator 114 to activate and deactivate a ride control function. To do so, the ride control valve 300 includes a valve body 302 and a ride control spool 306 that is housed within the valve body 302. The ride control spool 306 is configured to move within the valve body 302 between a plurality of ride control positions to selectively couple the pump 106, the tank 110, the actuator 114, and the accumulator 116, and the respective ports thereof. More specifically, the ride control spool 306 is configured to be arranged in a plurality of ride control configurations, and the ride control spool 306 can be moved between the plurality of ride control positions to switch between ride control configurations, as discussed below. Correspondingly, in the illustrated non-limiting example, the valve body 302 can define a pump passage 304 configured to couple to the pump 106, a tank passage 308 configured to couple to the tank 110, a work passage 312 configured to couple to the actuator 114 (e.g., via the work port 112 and the work passage 212 of the directional control valve 200), and an accumulator passage 318 configured to couple to the accumulator 116.

As described in greater detail below, the ride control spool 306 may be actuated between the plurality of ride control configurations to control various states and functions of the ride control valve 300. In the illustrated non-limiting example, the ride control spool 306 can be configured to move between five ride control configurations. The first ride control configuration can be configured to couple the accumulator 116 to the tank 110 to discharge (i.e., depressurize) the accumulator 116 by blocking the work passage 312 and the pump passage 304, and coupling the accumulator passage 318 to the tank passage 308. The second ride control configuration can be configured to couple the pump 106 to the accumulator 116 to charge (i.e., pressurize) the accumulator 116 by blocking the tank passage 308 and the work passage 312, and coupling the pump passage 304 to the accumulator passage 318. The second ride control configuration can also be configured to selectively balance a pressure of the accumulator 116 with the pressure of the work port 112 (e.g., a pressure of the actuator pressure) by blocking the work passage 312 and selectively coupling the accumulator passage 318 with each of the pump passage 304 and the tank passage 308. The third ride control configuration can be configured to couple the accumulator 116 to the actuator 114 to activate the ride control function by blocking the pump passage 304 and the tank passage 308 and coupling the accumulator passage 318 with the work passage 312. It is appreciated that the second configuration can be an infinitely variable configuration between the first ride control configuration and the third ride control configuration to provide an infinitely variable charge rate to the accumulator 116. It is appreciated that, where multiple work ports are provided, only some work ports may be coupled to the accumulator 116. For example, in the case of a double-acting cylinder that is couple to two work ports, a first work port 112A can be coupled to the accumulator 116 while a second work port 112B can be coupled to tank.

In the illustrated non-limiting example, the ride control spool 306 is a spring-biased ride control spool that includes a biasing assembly 320 to bias the ride control spool 306 into the first ride control position, i.e., the first ride control configuration. More specifically, the biasing assembly 320 includes a first compliant member 322 (e.g., a first control spring or other type resilient member) and a second compliant member 324 (e.g., a second control spring or other type of resilient member) that are arranged in series with one another. More specifically, the first control spring 322 extends and is retained between a spring seat 326 and a first spool seat 328, as well as between the spring seat 326 and the ride control spool 306 (e.g., via a retainer 329 coupled to the ride control spool 306). The spring seat 326 is movably coupled to the ride control spool 306 and can slide along the ride control spool 306 to allow relative movement therebetween. The first spool seat 328 is configured as a floating seat that is movably disposed within the valve body 302, and the second control spring 324 extends between the first spool seat 328 and a second spool seat 330.

Correspondingly, the first control spring 322 and the second control spring 324 can be compressed between the spring seat 326 (e.g., the ride control spool 306) and the second spool seat 330 as the ride control spool 306 moves from the first configuration, through the second configuration, and finally to the third configuration. More specifically, the second spring 324 can have sufficient initial precompression (e.g., an initial preload) such that the first control spring 322 will compress first. That is, the initial precompression of the second spring 324 can be selected so that the first control spring 322 fully compresses (e.g., in the second configuration when the ride control spool 306 makes initial contact with the first spool seat 328 to provide a balancing function) without compression of the second control spring 324. Without compression, means that the second control spring 324 does not compress by more than about 5-percent of its initial pre-compressed length when the ride control spool 306 is in each of the first and second control configurations. It is appreciated that both the first control spring 322 and the second control spring 324 can be set with an initial preload compression so the ride control spool 306 is biased to the first configuration.

To move the ride control spool 306 between the various ride control positions and/or configurations, the ride control valve 300 can include an electrohydraulic pressure regulating valve 332 (EPRV). In some cases, the EPRV 332 can be a solenoid actuator or other type of actuating device. The EPRV 332, and thus the ride control spool 306, can be controlled by a controller 128 (e.g., an electronic controller). That is, the controller 128 can selectively energize the EPRV 332 to overcome the biasing force of the biasing assembly 320 to move the ride control spool 306 between the various positions and/or configurations. The controller 128 can be a controller of the hydraulic machine (e.g., the same controller used to operate the directional control valve 200), or another controller.

In some cases, the controller 128 can move the ride control spool 306 based on a sensed pressure of one or both of the actuator 114 and the accumulator 116. That is, the controller can be configured to determine the pressure difference between the work port pressure and the accumulator pressure and to control the ride control spool 306 based on that determined pressure difference. Accordingly, the ride control system 100 can include a first sensor 122 configured to measure the work port pressure (i.e., the actuator pressure) and a second sensor 124 configured to measure the accumulator pressure. The controller 128 can receive a signal from each of the first sensor 122 and the second sensor 124, which can be used to determine the pressure difference between the work port pressure and the accumulator pressure.

With continued reference to FIGS. 1, 2, and 3, as mentioned above, the accumulator 116 can store a pressurized volume of hydraulic fluid. The ride control valve 300, via movement of the ride control spool 306, can be configured to charge and discharge the accumulator to store a volume of fluid at a desired pressure. Correspondingly, in some configurations, the ride control valve 300 may include a charge limit relief valve 336 and a max pressure relief valve 338 for the accumulator 116. The charge limit relief valve 336 may further set a desired charge pressure, and can allow a pump compensator (see, e.g., compensator 346, below) to close when the accumulator charge limit is reached. In some configurations, the accumulator 116 may discharge fluid to the tank 110 via the charge limit relief valve 336 when a charge limit pressure is achieved. In this configuration, the pump compensator 346 closes the pump supply to accumulator passage, and charge limit relief valve 336 flow to tank 110 is limited to the flow across flow limiting orifice 341, preventing excessive hydraulic power losses. Additionally, the accumulator 116 may discharge fluid via the max pressure relief valve 338 to the tank 110, once a set maximum pressure is achieved in the accumulator 116. Accordingly, the max pressure relief valve 338 can be an automatic relief valve to prevent the accumulator 116 from over-pressurizing. Relatedly, the ride control valve 300 can further include a manual or emergency discharge valve 342 to allow an operator to manually couple the accumulator 116 to tank 110 (e.g., internally to the ride control valve 300). Operating the emergency discharge valve 342 does not affect the pressure setting of either the charge limit relief valve 336 or the max pressure relief valve 338.

Relatedly, it is generally preferable to match an accumulator pressure with the actuator pressure prior to activating the ride control function (e.g., by moving the ride control spool into the third configuration to couple the accumulator 116 to the actuator 114). For example, in some cases, the ride control system 100 may be configured to block the ride control spool 306 from moving to the third configuration (e.g., via operation of the controller), unless a pressure difference between the work passage 312 (e.g., the work port 112) and the accumulator passage 318 is less than a predetermined pressure differential (e.g., about 3 bar to about 5 bar, or another pressure value).

To balance the accumulator pressure with the actuator pressure, the ride control valve 300 can include a pressure balancing spool 400 configured to selectively couple the accumulator 116 to the pump 106 and the tank 110 (e.g., via their respective passages in the ride control valve 300). In the illustrated non-limiting example, the pressure balancing spool 400 can move between three positions, namely, a neutral position, a first balancing position, and a second balancing position. In the neutral position, the pressure balancing spool 400 disconnects the accumulator 116 from the pump 106 and the tank 110 by blocking the accumulator passage 318 from both the pump passage 304 and the tank passage 308, such that pressure of the accumulator 116 does not change. In the first balancing position (e.g., a discharging position), the pressure balancing spool 400 connects the accumulator 116 to the tank 110 by blocking the pump passage 304 and coupling the accumulator passage 318 to the tank passage 308. As a result, high pressure fluid from the accumulator 116 will flow to the tank 110 to depressurize and discharge the accumulator 116. In the second balancing position (e.g., a charging position), the pressure balancing spool 400 connects the accumulator 116 to the pump 106 by blocking the tank passage 308 and coupling the accumulator passage 318 to the pump passage 304. As a result, high pressure fluid from the pump 106 will flow to the accumulator 116 to pressurize and charge the accumulator 116. It is appreciated that, in the illustrated non-limiting example, the pressure balancing spool 400 is selectively coupled with the pump 106, tank 110, and accumulator 116 via the ride control spool 306, and thus flow through the pressure balancing spool 400 may be dependent on a position and/or configuration of the ride control spool.

As shown in the illustrated non-limiting example, the pressure balancing spool 400 can be configured as a double-biased valve that can move between the neutral position and each of the first and second balancing positioned based on pressure differential between the work passage 312 and the accumulator passage 318. More specifically, the pressure balancing spool 400 can include a biasing assembly 420 configured to bias the pressure balancing spool 400 into the neutral position when a pressure difference between the work passage 312 and the accumulator passage 318 is less than a predetermined pressure differential. In this case, the biasing assembly 420 includes a first compliant member 422 (e.g., a first balancing spring or other type resilient member) and a second compliant member 424 (e.g., a second balancing spring or other type of resilient member) that are arranged in an opposed configuration. It is appreciated that the predetermined pressure differential can be set based on a spring installed force of the first balancing spring 422 and the second balancing spring 424. Further, the predetermined pressure differential can act to provided hysteresis to the ride control system 100 that can reduce rapid changes in position of the pressure balancing spool 400, which may occur due to a load on the actuator 114 being varied.

Due to the opposed configuration of the first balancing spring 422 and the second balancing spring 424, biasing assembly 420 causes the pressure balancing spool 400 to attain the neutral position when the pressure difference between the work passage 312 and the accumulator passage 318 is less than the predetermined pressure differential. However, when the pressure difference between the work passage 312 and the accumulator passage 318 is greater than the predetermined pressure differential, the pressure difference can overcome the spring forces and move the pressure balancing spool 400 to either of the first balancing position and second balancing position. In other non-limiting examples, a biasing assembly can be arranged in other ways. For example, a biasing assembly can include compliant members arranged in series with one another.

This movement results from connecting a first end of the pressure balancing spool 400 to the work passage 312, and an opposing, second end of the pressure balancing spool 400 to the accumulator passage 318. Accordingly, when the pressure in the accumulator passage 318 (i.e., the actuator pressure) is greater than the pressure in the work passage 312 (i.e., the accumulator pressure), the pressure balancing spool 400 can move to the first balancing position to discharge and depressurize accumulator 116. Conversely, when the pressure in the work passage 312 is greater than the pressure in the accumulator passage 318, the pressure balancing spool 400 can move to the second balancing position to charge and pressurize the accumulator 116, or a single spring that can bias to the neutral position in both directions.

To prevent flow to the pump 106 in the first and second balancing positions (e.g., when balancing the accumulator pressure with the pump 106 “off” or supplying fluid at a lower pressure than that of the accumulator), a check valve 344 or other type of non-return valve can be positioned along the pump passage 304, between the pressure balancing spool 400 and the ride control spool 306 (e.g., the pump 106). Correspondingly, to reduce a pump pressure to a predetermined margin greater than the accumulator pressure, the ride control valve 300 can further include a compensator 346 positioned along the pump passage 304, between the pressure balancing spool 400 and the ride control spool 306 (e.g., the pump 106). The compensator 346 may be coupled to the accumulator 116 to sense the charge pressure of the accumulator 116. In the illustrated non-limiting example, the compensator 346 is positioned between the check valve 344 and the pressure balancing spool 400.

In some cases, the pressure balancing spool 400 can be advantageously arranged relative to the ride control spool 306 to provide more compact packaging and to allow the ride control function to be operated using a single EPRV. For example, as illustrated in FIG. 3, in particular, the pressure balancing spool 400 can be movable relative to, and secured within, the ride control spool 306. That is, the pressure balancing spool 400 can be movably disposed within a chamber 348 (e.g., a bore) that is defined within the ride control spool 306 (e.g., to be nested within the ride control spool 306). More specifically, the pressure balancing spool 400 and the ride control spool 306 can be coaxial with one another, such that each can move along an axis 360 between their respective positions. In other non-limiting examples, the pressure balancing spool 400 can be arranged differently, for example, to be spaced apart from the ride control spool 306 while remaining within the ride control valve 300.

Correspondingly, the biasing assembly 420 can also be disposed within the ride control spool 306 to bias the pressure balancing spool 400 relative to and within the ride control spool 306. In particular, the first balancing spring 422 can be positioned to apply a first biasing force between a first end of the pressure balancing spool 400 and the ride control spool 306 and the second balancing spring 424 can be positioned to apply a second, opposing biasing force between a second end of the pressure balancing spool 400 and the ride control spool 306. In this case, the first balancing spring 422 is retained on the pressure balancing spool 400 by a first retainer 426 and the second balancing spring 424 is retained on the ride control spool 306 by a second retainer 428. In other non-limiting examples, the biasing assembly 420 can be arranged differently.

With continued reference to FIGS. 1 2, and 3, in some non-limiting examples, the main control valve 102 can optionally include a low leak check valve 126 to reduce leakage from the actuator 114 to the main control valve 102, and thus, reduce actuator drift. By incorporating the ride control valve 300 into the main control valve 102, the low leak check valve 126 can be coupled to the work passage 312 between the work port 112 and the connection with the ride control work passage 312. Put another way, the low leak check valve 126 can be coupled along the work passage 312 between the work port 112 and the ride control spool 306. This differs from conventional arrangements that require external conduits to couple a ride control valve to an actuator, typically with the ride control spool and accumulator between the low leak check valve and the actuator 114. Correspondingly, the low leak check valve 126 arrangement as described herein, can reduce leakage to the ride control valve 300 to reduce actuator drift. In this way, the ride control valve 300 will have little to no effect on a leakage rate of the actuator 114. Additionally, this arrangement allows for wider manufacturing tolerances to be used without affecting system performance.

In this case, the low leak check valve 126 has a side port 127 that is coupled with the work port 112 and the actuator 114, and a nose port 129 that is coupled with work passage 312 of the ride control valve 300 (e.g., to couple to the accumulator 116). A poppet 131 is movably disposed within a control chamber 133, which is coupled to the directional control spool 206 and/or the ride control spool via a control passage 350. Accordingly, when the directional control spool 206 is actuated to couple the pump 106 to the actuator 114, the pressure at the nose port 129 can exceed the pressure at the side port 127 (and within the control chamber) to open the poppet 131 and allow flow from the pump 106 to the work port 112 and actuator 114. When the directional control spool 206 is actuated to couple the actuator 114 to tank 110, the directional control spool 206 opens the control passage 350 to couple the control chamber 133 to the nose port 129, and the nose port 129 to the tank 110. As a result, the side port 127 pressure will be greater than both the nose port 129 and control chamber 133 pressures to cause the poppet 131 to open and allow flow from the actuator 114 to the tank 110.

With regard to the ride control spool 306, when the ride control spool 306 is in the first, second, and third ride control configurations, the control passage 350 is blocked and the poppet 131 is closed to block the ride control spool 306 and accumulator 116 from the actuator 114. However, when the ride control spool 306 is in the fourth ride control configuration, the control passage 350 can be coupled with the nose port 129 via a non-return valve 352 provided in the ride control valve 300. While FIG. 1 illustrates the non-return valve 352 being provided in the ride control spool 306, it is appreciated that the non-return valve 352 can actually be provided within the pressure balancing spool 400, as shown in FIG. 3 or anywhere along the control passage 350.

The inclusion of the non-return valve 352 allows the poppet 131 to open to allow bidirectional flow between the accumulator 116 and the actuator 114, thereby allowing movement of the actuator 114 when the ride control function is activated. In particular, when the nose port 129 pressure is greater than the side port 127 pressure, non-return valve 352 blocks flow from the nose port 127 to the control chamber 133, while the control passage 350 allows flow from the control chamber 133 to the side port 127, resulting in the control chamber 133 pressure being equal to the side port 127 pressure to allow the poppet 131 to open and allow flow from the accumulator 116 to the actuator 114. Conversely, when the side port 127 pressure is greater than the nose port 129 pressure, the pressure in control chamber 133 will be closer to the nose port 129 pressure and the poppet 131 will open to allow flow from actuator 114 to the accumulator 116. It is appreciated that the control chamber 133 is closer to nose port 129 pressure because the pressure drop from side port 127 to the control chamber 133 across the control passage 350 will be higher than the pressure drop from control chamber 133 to the nose port 129.

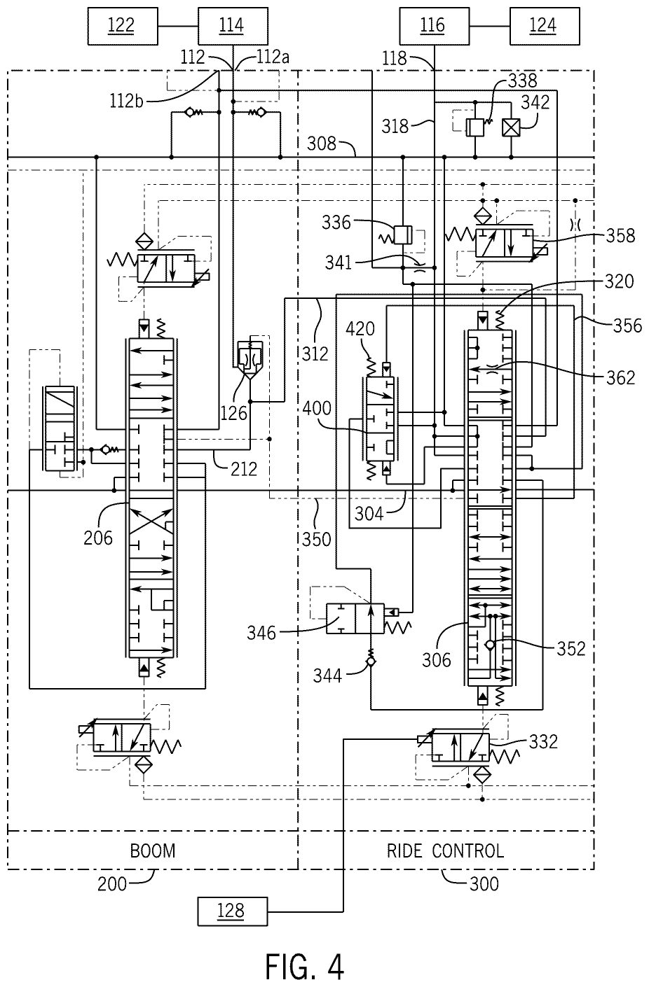

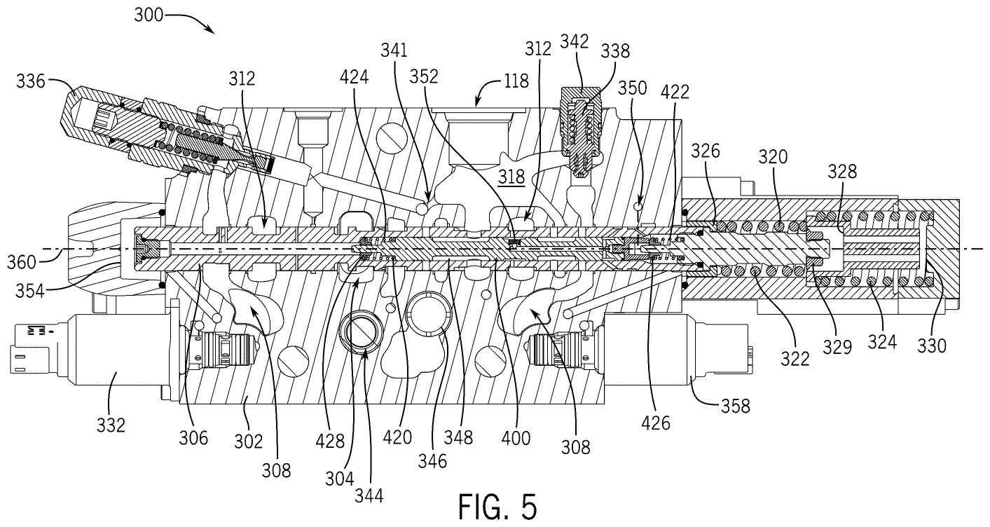

Referring now to FIGS. 4 and 5, in some non-limiting examples, the ride control valve 300 can also be configured to provide a warm-up function. That is, the ride control valve 300 can be configured to connect the pump 106 directly to the tank 110, via the ride control spool 306, to allow hydraulic fluid to circulate through the ride control valve 300 and other system components to heat the system to a desired operating temperature. More specifically, the ride control valve 300 can allow a proportional, limited, and compensated flow from pump passage to tank passage. An additional orifice between EPRV 358 output and sump passage can circulate flow through pilot and sump conduits. Both of the above connections can be used to heat the main control valve 102 and the system hydraulic fluid to a desired operating temperature. The warm-up function can be operated independently of the directional control valve 200 or other functions (e.g., a bucket or other function).

For example, to provide a warm-up function, the ride control spool 306 can be configured to move to a fifth ride control configuration. More specifically, the ride control spool 306 can be moved from the first ride control configuration, in a direction opposite (e.g., away from) the second, third, and fourth ride control configurations. As described in greater detail below, in the fifth ride control configuration, the ride control spool 306 can be moved axially (e.g., along the axis 360) away from the first, second, third and/or fourth ride control configurations to be in contact with a third spool seat 354, which can be defined by the valve body 302, at an end opposite the second spool seat 330.

In the fifth ride control configuration, the ride control spool 306 couples the pump passage 304 to the tank passage 308 to allow fluid to circulate through the system. In some cases, the pump 106 can be coupled to the compensator 346 and/or a restriction orifice 362 that can be provided within the ride control spool 306, which can provide a restriction to cause heating of the fluid. Additionally, in the fifth ride control configuration, the accumulator passage 318 can be coupled to the tank passage 308, while the work passage 312 is blocked. Relatedly, to move the ride control spool 306 to the fifth ride control configuration, the ride control valve 300 can include second EPRV 358. The second EPRV 358 can be selectively energized by the controller 128.

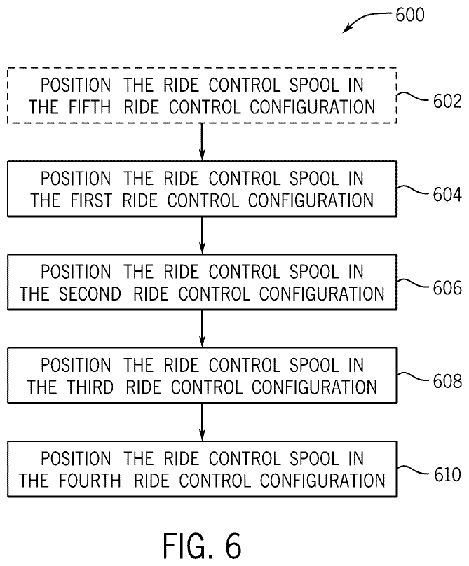

Continuing with reference to FIG. 6, a method 600 for controlling a ride control valve for a hydraulic machine is illustrated. While the method 600 is described with reference to the ride control system 100 of FIGS. 1-5, it is understood that the method 600 can also be used with other non-limiting examples of ride control systems. Further, it is appreciated that various steps of the method 600 do not need to be carried out in any particular order.

As generally mentioned above, the controller 128 can selectively energize the EPRV 332 to move the ride control spool 306 between the plurality of ride control positions and/or configurations. In particular, at block 604, the ride control spool 306 can be positioned in the first ride control position, i.e., in the first ride control configuration. The first ride control configuration can correspond with an “off” or deactivated state of the ride control valve 300. Specifically, and with additional reference to FIGS. 3, 5, and 7, the controller 128 can energize to the EPRV 332 to configuration the ride control spool 306 in the first ride control configuration, for example, by applying a first electrical current to the EPRV 332. The first electrical current can be range of electrical currents configured to axially position the ride control spool 306 to discharge the accumulator 116 (e.g., between about 0 and about 400 milliamperes). In some cases, the first electrical current may be zero milliamperes, such that the controller 128 de-energizes the EPRV 332. That is, because the ride control spool 306 can be biased to the first ride control configuration by the biasing assembly 320, the controller 128 may not energize the EPRV 332 to allow the biasing assembly 320 to apply a force to the ride control spool 306 and retain it in the first ride control configuration.

As generally mentioned above, in the first ride control configuration, the accumulator 116 is coupled to discharge to tank 110, and the accumulator 116 can be blocked from both the pump 106 and the actuator 114. In the first ride control configuration, the first control spring 322 and the second control spring 324 can each be in a preloaded or uncompressed state, such that the ride control spool 306 is spaced from the first spool seat 328 by a first distance. Accordingly, the first control spring 322 and the second control spring 324 can each be at a respective preloaded or initial spring length. The first control spring 322 can extend between the spring seat 326 and the retainer 329 and/or the first spool seat 328. Relatedly, the ride control spool 306 can be spaced from the third spool seat 354 and the first spool seat 328 can be spaced from the second spool seat 330.

With regard to the actuator 114, the low leak check valve 126 can be closed so that the ride control valve 300 does not contribute to the leakage rate of the actuator 114. Relatedly, in the first configuration, the pressure balancing spool 400 can be vented to tank 110 so that the pressure balancing spool 400 is in the neutral position.

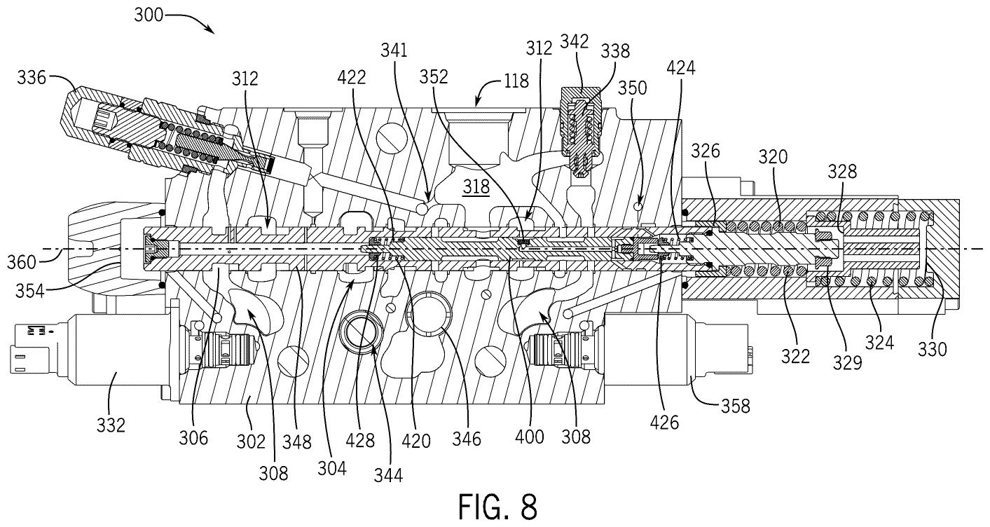

At block 606, and with additional reference to FIG. 8, the ride control spool 306 can be arranged in the second ride control configuration (e.g., a charging configuration). The second ride control configuration can correspond with charging state of the ride control valve 300 that is configured to supply fluid to increase the pressure of the accumulator 116 (e.g., to charge the accumulator 116). The controller 128 can selectively energize the EPRV 332 to axially position the ride control spool 306 at the second ride control configuration. For example, the controller 128 can provide a second electrical current value to the EPRV 332. The second electrical current can be a range of electrical currents configured to axially position the ride control spool 306 to charge the accumulator 116 (e.g., between about 550 milliamperes and about 700 milliamperes).

As generally mentioned above, the second ride control configuration can be a variable configuration to allow a charging flow rate of the accumulator 116 to be adjusted between a minimum and a maximum charging flow rate. Accordingly, the second ride control configuration can include a range of axial positions that block the tank passage 308 and the work passage 312 and couple the accumulator passage 318 to the pump passage 304. In the illustrated non-limiting example, the controller 128 can operate under a proportional control mode to vary an electrical current supplied to the EPRV 332 to adjust the ride control spool 306 with the range of axial positions to vary an open area between the accumulator passage 318 and pump passage 304. By controlling the size of the open area, the charging rate of the accumulator 116 is also controlled.

In the second ride control configuration, the ride control spool 306 is moved toward the first spool seat 328 and the second spool seat 330. More specifically, the ride control spool 306 remains spaced from the first spool seat 328 by a second distance (e.g., a second distance) that is less than the first distance, and the first spool seat 328 remains spaced from the second spool seat 330. In doing so, the spring seat 326 can engage and move with the ride control spool 306 to compress the first control spring 322 between the spring seat 326 and the first spool seat 328, such that the first control spring 322 is at a second spring length (e.g., an intermediate spring length). The retainer 329 may disengage from the first control spring 322 in the second ride control configuration. It is appreciated that the second control spring 324 may remain at about its maximum length (e.g., to be substantially uncompressed as compared with the first ride control configuration). More specifically, due to the higher preload on the second control spring 324, the second control spring will not further compress in the second ride control configuration and will remain at is preloaded length.

With regard to the actuator 114, the low leak check valve 126 will be closed so that the ride control valve 300 does not contribute to the leakage rate of the actuator 114. Relatedly, in the first configuration, the pressure balancing spool 400 will be moved into the second balancing position to couple the accumulator passage 318 to the pump passage 304, within the ride control spool 306.

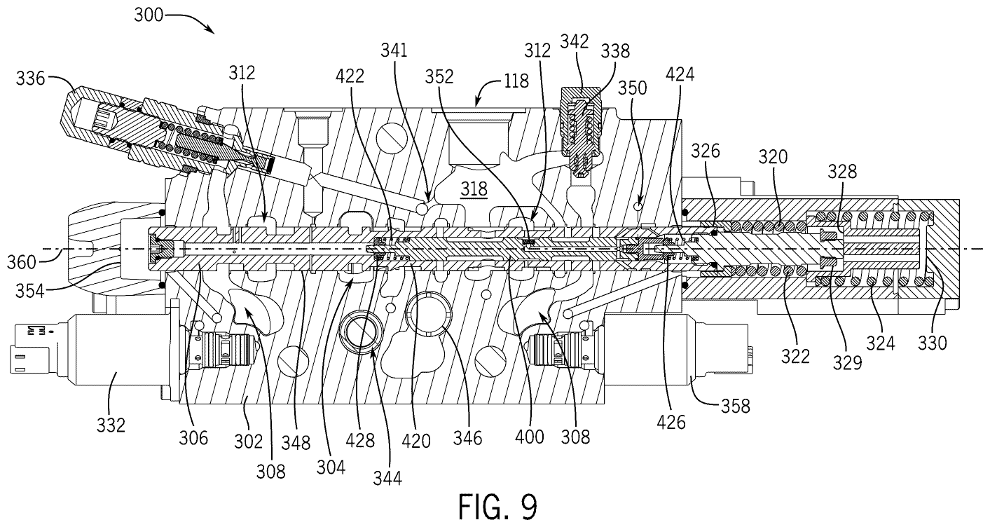

At block 608, and with additional reference to FIG. 9, the ride control spool 306 can be arranged in arranged in the third ride control configuration, (e.g., a balancing configuration). The third ride control configuration can correspond with a balancing state of the ride control valve 300 that is configured to match the accumulator pressure with the actuator pressure. That is, for example, the ride control valve 300 can charge and discharge the accumulator 116 to bring the accumulator pressure withing a predetermined pressure differential from the actuator pressure. Accordingly, the controller 128 can energize the EPRV 332 to axially position the ride control spool 306 at the third ride control configuration. For example, the controller 128 can provide a third electrical current value to the EPRV 332. The third electrical current can be a range of electrical currents configured to axially position the ride control spool 306 to balance the accumulator pressure with the actuator pressure (e.g., between about 800 milliamperes and about 1000 milliamperes).

In the third ride control configuration, the ride control spool 306 is moved toward the first spool seat 328 and the second spool seat 330 so that the work passage 312 is blocked, and the accumulator passage 318 can be selectively coupled with the tank passage 308 and the pump passage 304 via the pressure balancing spool 400. More specifically, the ride control spool 306 is moved into contact with the first spool seat 328, which remains spaced from the second spool seat 330. In doing so, the spring seat 326 moves with the ride control spool 306 to further compress the first control spring 322 between the spring seat 326 and the first spool seat 328, such that the first control spring 322 is at a third spring length (e.g., minimum spring length). It is appreciated that, due to the higher initial preload of the second control spring 324, the second control spring 324 does not compress, such that the first spool seat 328 can function similarly to a hard or immovable seat in the third ride control configuration. The retainer 329 may be disengaged from the first control spring 322 the second control spring 324 may be substantially uncompressed from its maximum length (e.g., at the first ride control configuration).

With the ride control spool 306 in the third ride control configuration, a first end of the pressure balancing spool 400 (e.g., a discharge end) is coupled to the accumulator passage 318 and a second end of the pressure balancing spool 400 (e.g., a charge end) is coupled to an actuator passage 356 (coupled to the actuator 114) to provide pressure compensation for the biasing assembly 420. Accordingly, when the accumulator pressure is greater than the actuator pressure by the predetermined pressure differential, the pressure balancing spool 400 can move to the first balancing position to discharge and depressurize accumulator 116. When the actuator pressure is greater than the accumulator pressure by the predetermined pressure differential, the pressure balancing spool 400 can move to the second balancing position to charge and pressurize the accumulator 116. When the actuator pressure and the accumulator pressure are within the predetermined pressure differential from one another, the biasing assembly 420 causes the pressure balancing spool 400 to move to the neutral position to maintain the accumulator pressure within the predetermined pressure differential from the actuator pressure. The pressure balancing spool 400 can move independently of the ride control spool 306, such that the pressure balancing spool 400 moves between the neutral and first and second balancing positions, while the ride control spool 306 can remain stationary in the third ride control configuration.

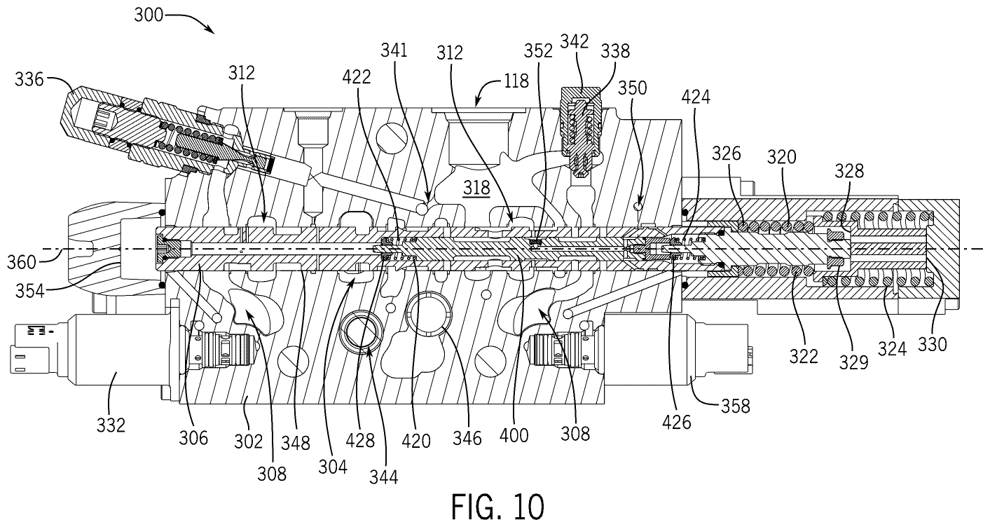

At block 610, and with additional reference to FIG. 10, the ride control spool 306 can be arranged in the fourth ride control configuration. The fourth ride control configuration can correspond with activated state of the ride control valve 300 that is configured to activate the ride control function by coupling the actuator 114 with the accumulator 116. Accordingly, the controller 128 can energize the EPRV 332 to axially position the ride control spool 306 at the fourth ride control configuration. For example, the controller 128 can provide a fourth electrical current value to the EPRV 332. The fourth electrical current can be a range of electrical currents configured to axially position the ride control spool 306 to couple the accumulator 116 to the actuator 114 (e.g., between greater than 1300 milliamperes). In some cases, the fourth current command can be a 100% current command and the first, second, and third current commands can be proportionally lesser command (e.g., between about 0% and about 30%, between about 40% and about 55%, and between about 60% and about 80%, respectively).

In some cases, the controller 128 may be configured to move the ride control spool 306 to the fourth configuration only when the pressure difference between the accumulator 116 and the actuator 114 is less than the predetermined pressure differential. Correspondingly, the controller 128 can be configured to determine the pressure difference between the work port pressure and the accumulator pressure, based on a signal from each the first sensor 122 and the second sensor 124.

In the fourth ride control configuration, the ride control spool 306 is moved toward the first spool seat 328 and the second spool seat 330 so that the tank passage 308 and the pump passage 304 are blocked, and the accumulator passage 318 is coupled with the work passage 312. More specifically, the ride control spool 306 is moved to cause the first spool seat 328 to move into contact with the second spool seat 330. This causes the second control spring 324 to be fully compressed between the first spool seat 328 and the second spool seat 330.

Relatedly, the pressure balancing spool 400 can move within the ride control spool 306 to block the tank passage 308 and the pump passage 304. Additionally, the accumulator 116 will be coupled with the actuator 114 via the low leak check valve 126, which, as generally described above, can allow fluid to flow between the actuator 114 and the accumulator 116 in response to fluctuating actuator pressures caused by, for example, the hydraulic machine traveling along an uneven support surface. That is, the low leak check valve 126 can allow for bi-directional flow between the actuator 114 and the accumulator 116.

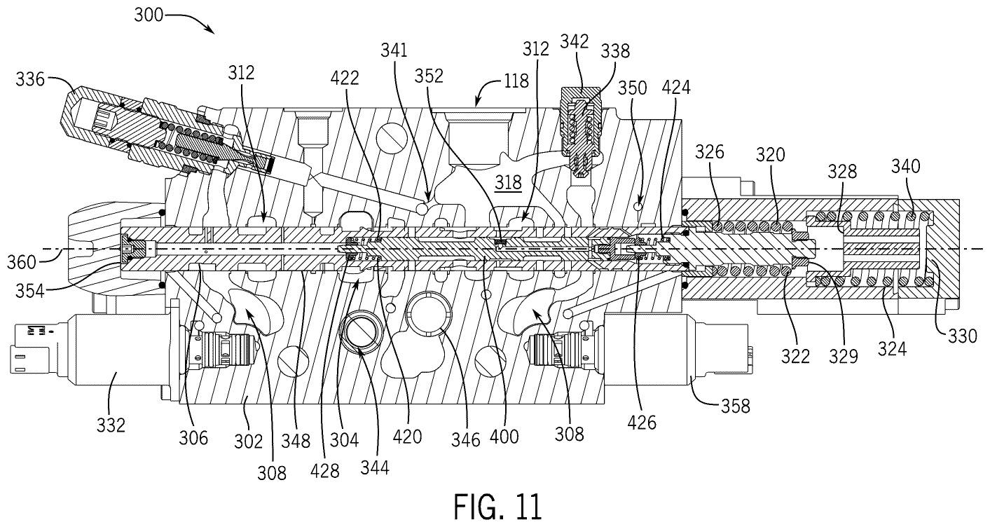

At block 602, and with additional reference to FIG. 11, the ride control spool 306 can be arranged in the fourth ride control configuration. The fifth ride control configuration can correspond with a warm-up state of the ride control valve 300 that is configured to allow fluid to circulate through the system. Accordingly, the controller 128 can energize the second EPRV 358 to axially position the ride control spool 306 at the fifth ride control configuration. For example, the controller 128 can provide an electrical current value to the second EPRV 358. The electrical current can be a range of electrical currents configured to axially position the ride control spool 306 to couple the pump 106 to the tank 110 (e.g., between about 800 milliamperes and about 1000 milliamperes). Additionally, the accumulator 116 can be coupled to the tank 110.

In the fifth ride control configuration, the ride control spool 306 is moved away from the first, second, third, and fourth ride control configurations, such that the ride control spool 306 contacts the third spool seat 354. Correspondingly, the spring seat 326 can engage the valve body 302 and the ride control spool 306 can slide through the spring seat 326. As a result, the first control spring is compressed between the spring seat 326 and the retainer 329. The second control spring 324 remains at its maximum length between the first spool seat 328 and the second spool seat 330, since the first spool seat 328 can be prevented from moving toward the ride control spool 306 by engagement with the valve body 302.

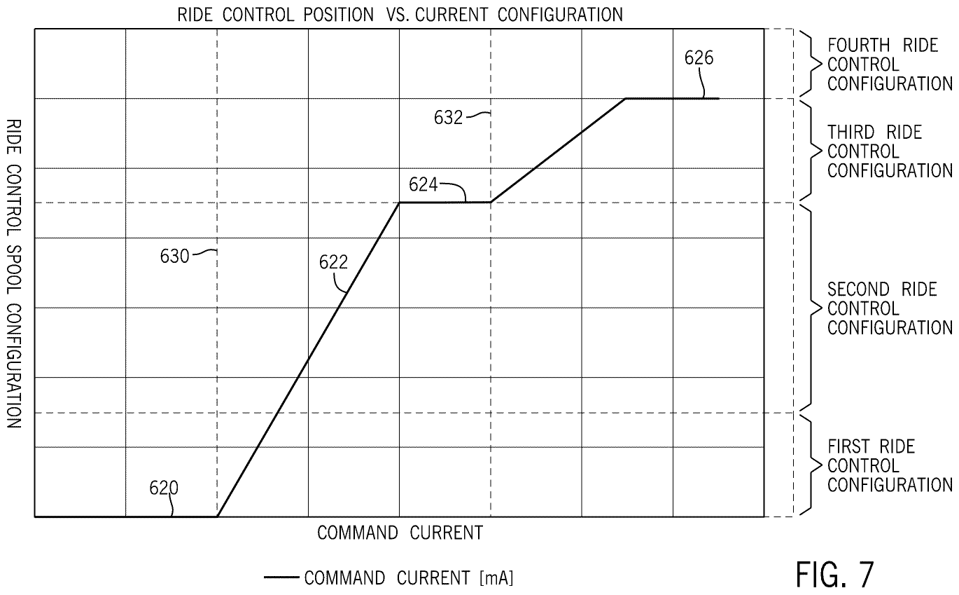

FIG. 7 illustrates the relationship between the ride control configuration of the ride control spool 306 and the command current delivered to the EPRV 332. As generally mentioned above, in the first ride control configuration, the first control spring 322 can be preloaded. In the first ride control configuration, the first control spring 322 may be preloaded so that the first control spring 322 does not further compress unless acted upon by a first threshold compression force. In some non-limiting examples, the EPRV 332 may begin to compress the first control spring 322, by overcoming the first threshold compression force, for example, once a first threshold current energizes the EPRV 332. Energizing current supplied to the EPRV 332 that is greater than the first threshold current can cause the EPRV 332 to displace the ride control spool 306 from the first ride control configuration, i.e., the first ride control position, through the second ride control configuration, to the third ride control configuration. In some non-limiting examples, the ride control spool 306 may be displaced from the first to the third ride control configuration, proportionally to the current supplied to the EPRV 332 in excess of the first threshold current.

Still referring to FIG. 7, similar to the first control spring 322, the second control spring 324 can be preloaded so that the second control spring 322 is not further compressed unless acted upon by a second threshold compression force. The second threshold compression force can be greater than the first threshold compression force, such that the first ride control spring 322 may be fully compressed without compression of the second control spring 324. The ride control spool 306 may therefore not be actuated from the third ride control configuration to the fourth ride control configuration, until the second threshold compression force of the second spring 322 is overcome. Correspondingly, the EPRV 332 may begin to compress the second control spring 324 by overcoming the second threshold compression force, for example, once a second threshold current energizes the EPRV 332. Energizing current supplied to the EPRV 332 that is greater than the second threshold current, can cause the EPRV 332 to displace the ride control spool 306 from the third ride control configuration (or any other ride control configuration) to the fourth ride control configuration. In some non-limiting examples, the ride control spool 306 may be displaced from the third to the fourth ride control configuration, proportionally to the current supplied to the EPRV 332 in excess of the second threshold current.

Accordingly, in one non-limiting example, to move the ride control spool 306 from the first ride control configuration to the third ride control configuration, the controller 128 can supply a first threshold current 630 to overcome the preload of the first control spring 322 and initially move the ride control spool 306 from the first ride control configuration (e.g., at line 620) toward the second ride control configuration. Subsequently, supplying an increasing command moves the ride control spool 306 from the first ride control configuration, through the second ride control configuration (e.g., at line 622), at a first proportional rate until the ride control spool 306 contacts the first spool seat 328 to fully compress the first control spring 322 and achieve the third ride control configuration (e.g., at line 624). At this point, further movement of the ride control spool 306 toward the fourth ride control configuration, is resisted by the second control spring 324, until a second threshold current 632 is supplied. Once the second threshold current 632 is supplied, a further increase in the current moves the ride control spool 306 from the third ride control configuration, at a second proportional rate until the ride control spool 306 contacts the second spool seat 330 to fully compress the second control spring 324 and achieve the fourth ride control configuration (e.g., at line 626).

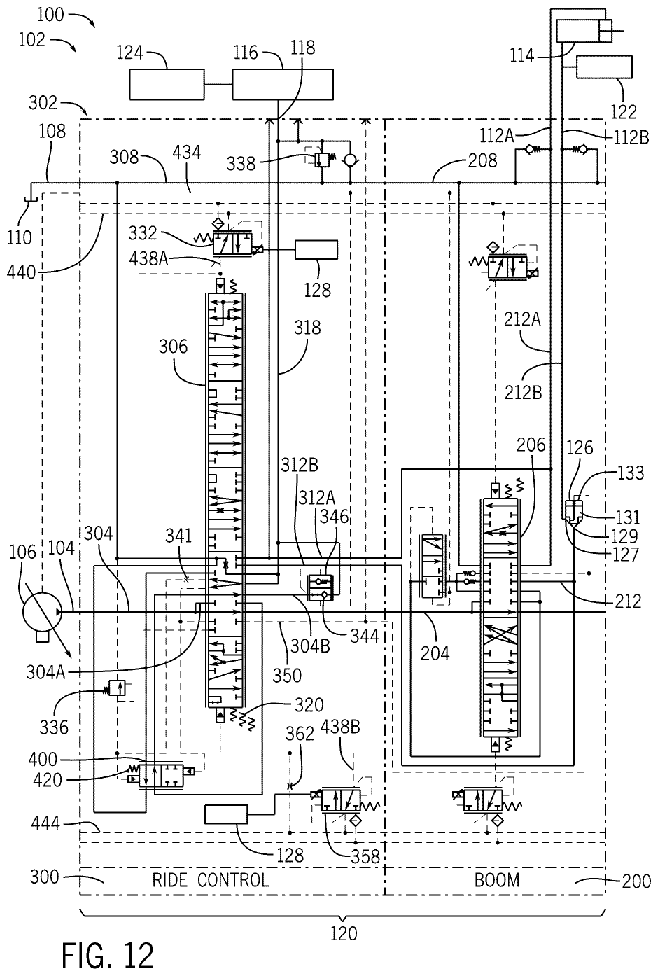

FIGS. 12-21 illustrate various aspects of an implementation of a ride control system, according to another aspect of the present disclosure. In this example, elements that are shared with—i.e., that are structurally and/or functionally identical or similar to—elements present in the ride control system 100 illustrated in FIGS. 1-11 are represented by like reference numerals. In the interest of brevity, some features of this example that are shared with the example of FIGS. 1-11 are numbered or labeled in FIGS. 12-21 but are not discussed in the specification.

Referring to FIG. 12, as described above, hydraulic machines may include a ride control system 100 to provide dampening to vehicle functions such as booms, buckets, lift arms, or other implements or attachments as a hydraulic machine travels over uneven terrain or another support surface. In some configurations, a hydraulic machine may include a main control valve 102 for controlling the vehicle functions, which can include a pump port 104 configured to couple to a pump 106 of the hydraulic machine, a tank port 108 configured to couple to a tank 110 of the hydraulic machine, a work port 112 configured to couple to an actuator 114 of the hydraulic machine, and an accumulator port 118 configured to couple to an accumulator 116. Accordingly, operation of the main control valve 102 can selectively couple the pump 106, the tank 110, and the actuator 114, by selectively coupling any of the pump port 104, the tank port 108 and the work port 112. In some cases, a main control valve can include more than one work port. For example, the main control valve 102 can include a first work port 112A and a second work port 112B for coupling to either end of a double-acting cylinder (e.g., the head and rod of a boom, respectively). Specifically, the first work port 112A corresponding to a first end of a double-acting cylinder can be selectively coupled to the tank 110 while a second work port 112B corresponding to a second end of a double-acting cylinder can be selectively coupled to the accumulator 116.

In some cases, a main control valve can be a single control valve (i.e., a single valve block) that can be installed on a hydraulic machine, as compared with conventional designs where multiple valve blocks are provided to control, for example; each of a boom function, a ride control function, and a warm-up function. As will become apparent in the discussion below, providing a ride control system as a single valve block with other machine functions (e.g., as a sectional valve or monoblock valve) can achieve numerous benefits over conventional systems, including, for example, increased operating efficiency and reducing the need for separate controllers and external conduits to connect and operate the ride control system with the various machine functions.

As described above, the main control valve 102 may include valve sections 120 to control various functions of the hydraulic machine. For example, the valve sections 120 may include a boom section (e.g., a directional control valve 200) configured to operate the actuator 114, and a ride control section (e.g., a ride control valve 300) configured to selectively couple the actuator 114 to the accumulator 116, which can be directly coupled to one another. That is, a valve body of the directional control valve can be directly mechanically coupled to a valve body of the ride control valve. In some configurations, the valve sections 120 may further include other types of function sections, such as a bucket section, an auxiliary function section, as well as additional function sections for other functions. In some configurations, each of the valve sections 120 may be configured with internal passages to couple to the pump 106, the tank 110, the actuator 114, and the accumulator 116 to perform their respective operations.

To operate the actuator 114, the directional control valve 200 may include a directional control spool 206 that may be movable between a plurality of positions, i.e., configurations. Movement of the directional control spool 206 between the plurality of positions can control fluid flow into, out of, or between one or more passages formed within the directional control valve 200. For example, the directional control valve 200 (e.g., a valve body thereof) can include a pump passage 204 to couple to the pump 106, a tank passage 208 to couple to the tank 110, and a work passage 212 to couple to the actuator 114. In some cases, and as will be described in greater detail below, the work passage 212 can be configured to couple the directional control valve 200 to a ride control valve 300, allowing the actuator 114 to be selectively coupled to the accumulator 116 to activate and deactivate the ride control system 100. In some aspects, the directional control valve 200 can include multiple work passages to couple the directional control valve 200 to a ride control valve 300, such as, for example, a first work passage 212A corresponding to the first work port 112A and a second work passage 212B corresponding to the second work port 112B.

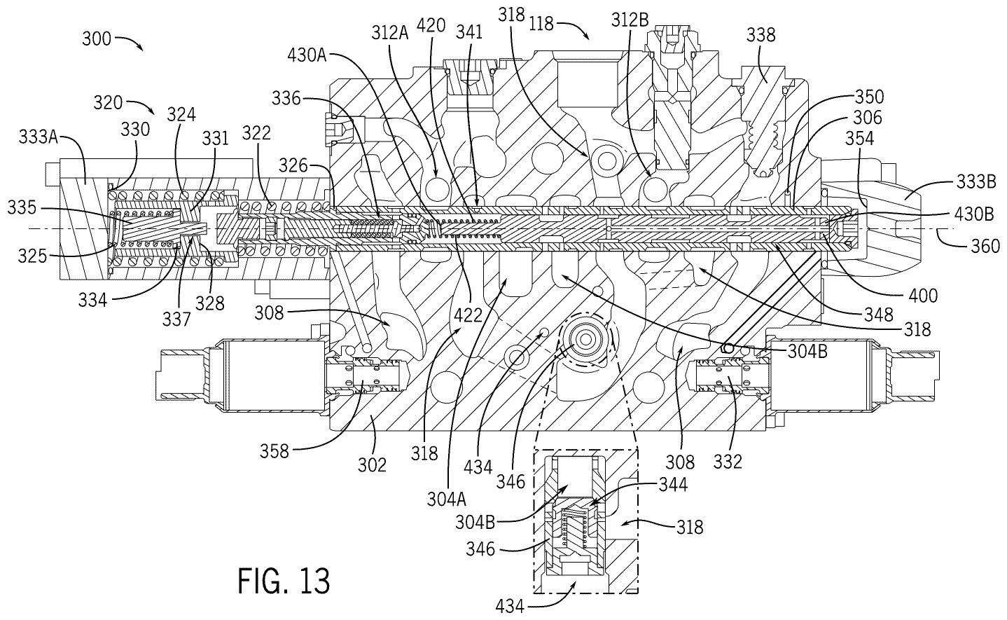

Referring now to FIGS. 12 and 13, the main control valve 102 includes the ride control valve 300, which can be configured to activate and deactivate a ride control function of the hydraulic machine to serve as a suspension for the boom or other work function. Put another way, the ride control valve 300 can selectively couple the accumulator 116 to the actuator 114 to activate and deactivate a ride control function. In addition, the ride control valve 300 can be configured to activate and deactivate a warm-up function of the hydraulic machine, as will be discussed below in greater detail. To perform these functions, the ride control valve 300 includes a valve body 302 and a ride control spool 306 that is housed within the valve body 302. The ride control spool 306 is configured to move within the valve body 302 between a plurality of ride control positions to selectively couple the pump 106, the tank 110, the actuator 114, and the accumulator 116, and the respective ports thereof.

Correspondingly, in the illustrated non-limiting example, the valve body 302 can define a pump passage 304 configured to couple to the pump 106, a tank passage 308 configured to couple to the tank 110, a work passage 312 configured to couple to the actuator 114 (e.g., via the work port 112 and the work passage 212 of the directional control valve 200), and an accumulator passage 318 configured to couple to the accumulator 116. In some aspects, the pump 106 can be indirectly coupled to the directional control valve 200 through the ride control valve 300. For example, the pump passage 204 can be configured to couple the directional control valve 200 to the ride control valve 300, and the pump passage 304 can be configured to couple the pump 106 to the ride control valve 300. In some aspects, the valve body 302 can define more than one work passage, such as a first work passage 312A configured to couple to the actuator 114 (e.g., via the first work port 112A, the first work passage 212A of the directional control valve 200, and the tank passage 308), and a second work passage 312B configured to couple to the actuator 114 (e.g., via the second work port 112B and the second work passage 212B of the directional control valve 200). In some examples, the pump passage 304 can include more than one pump passage, such as a first pump passage 304A configured to couple the pump 106 to the ride control spool 306, and a second pump passage 304B configured to couple the ride control spool 300 to a pressure compensator 346, as discussed below in greater detail.

As described in greater detail below, the ride control spool 306 may be actuated between the plurality of ride control positions to control various states and functions of the ride control valve 300. In the illustrated non-limiting example, the ride control spool 306 can be configured to move between five ride control positions. The first ride control position can be configured to couple the accumulator 116 to the tank 110 to discharge (i.e., depressurize) the accumulator 116 by blocking the work passage 312 and the pump passage 304, and coupling the accumulator passage 318 to the tank passage 308. The second ride control position can be configured to selectively couple the pump 106 to the accumulator 116 to charge (i.e., pressurize) the accumulator 116 by blocking the tank passage 308 and the work passage 312, and selectively coupling the pump passage 304 to the accumulator passage 318. The third ride control position can be configured to balance a pressure of the accumulator 116 with the pressure of the work port 112 (e.g., a pressure of the actuator 114) by blocking the pump passage 304 and the work passage 312 and selectively coupling the accumulator passage 318 with the tank passage 308. It is appreciated that the second position can be an infinitely variable position between the first ride control position and the third ride control position to provide an infinitely variable charge flow rate to the accumulator 116. The fourth ride control position can be configured to couple the accumulator 116 to the actuator 114 to activate the ride control function by blocking the pump passage 304 and the tank passage 308 and coupling the accumulator passage 318 with the work passage 312. It is appreciated that, where multiple work ports are provided, only some work ports may be coupled to the accumulator 116. For example, in the case of a double-acting cylinder that is coupled to two work ports, the first work port 112A can be coupled to the tank 110 while the second work port 112B can be coupled to the accumulator 116. Further, the fifth ride control position can be configured to couple the pump 106 and the accumulator 116 to the tank 110 to activate the warm-up function (e.g., to heat fluid circulating through the hydraulic machine to a desired operating temperature to warm up the system), as will be discussed below in greater detail.

In the illustrated non-limiting example, the ride control spool 306 is a spring-biased ride control spool that includes a biasing assembly 320 to bias the ride control spool 306 into the first ride control position. More specifically, as shown in FIG. 13, the biasing assembly 320 includes a first compliant member 322 (e.g., a first control spring or other type resilient member), a second compliant member 324 (e.g., a second control spring or other type of resilient member) that can be arranged in series with the first control spring 322, and a third compliant member 325 (e.g., a third control spring or other type of resilient member) that can be arranged in parallel with the first control spring 322 and the second control spring 324. More specifically, the first control spring 322 extends and is retained between a first spring seat 326 defined by the ride control spool 306 and a first spool seat 328 defined by a seat member 331. The seat member 331 is shown as a moveable seat. The first spring seat 326 can be movably coupled to the ride control spool 306 and can slide along the ride control spool 306 to allow relative movement therebetween, or the first spring seat 326 can be integrally formed with the ride control spool 306 such that the first spring seat 326 moves with the ride control spool 306. The seat member 331 can be movably disposed within the valve body 302, and the second control spring 324 can extend and be retained between the first spool seat 328 and a second spool seat 330 defined by a distal or first end 333A of the valve body 302. Correspondingly, a third spool seat 354 is defined by a second end 333B of the valve body 302 that is opposite the first end 333A, as discussed below. Further, the third control spring 325 can extend and be retained between the second spool seat 330 (i.e., the first end 333A of the valve body 302) and a second spring seat 334 defined by a pin 335 disposed within the seat member 331. The pin 335 may partially extend through a seat aperture 337 defined within seat member 331 so as to abut the ride control spool 306, as will be discussed below in greater detail.

Correspondingly, the first control spring 322, the second control spring 324, and the third control spring 325 can be compressed as the ride control spool 306 moves from the first position, through the second position to the third position, and finally to the fourth position. In some examples, the second spring 324 can have sufficient initial precompression (e.g., an initial preload) such that the first control spring 322 will compress first. That is, the initial precompression of the second spring 324 can be selected so that the first control spring 322 fully compresses (e.g., in the third position) when the ride control spool 306 makes initial contact with the first spool seat 328 and/or the pin 335 without compression of the second control spring 324. Without compression means that the second control spring 324 does not compress by more than about 5 percent of its initial pre-compressed length when the ride control spool 306 is in each of the first, second and third ride control positions. It is appreciated that both the first control spring 322 and the second control spring 324 can be set with an initial preload compression so the ride control spool 306 is biased to the first position.

As discussed above, the pin 335 may partially extend through the seat aperture 337 such that the ride control spool 306 makes initial contact with the pin 335 before contacting the first spool seat 328. Thus, the third control spring 325 can be partially compressed without compression of the second control spring 324. At a threshold point, however, the ride control spool 306 can contact the first spool seat 328 and compress both the second control spring 324 and the third control spring 325. Arranging the second control spring 324 and the third control spring 325 to be in parallel with one another can advantageously allow the ride control spool 306 to be more precisely actuated between the ride control positions, thereby increasing the efficiency of the ride control valve 300. For example, arranging the second and third control springs 324, 325 in parallel can increase the biasing force of the biasing assembly 320 to relative to a biasing force for a biasing assembly consisting of a single spring, which in turn can help the biasing assembly 320 to be more resistant against to minor fluctuations in spool position. Put another way, using two springs in the biasing assembly 320 can help to maintain the ride control spool 306 in a desired ride control position.

To move the ride control spool 306 between the various ride control positions, the ride control valve 300 can include one or more electrohydraulic pressure regulating valves (EPRVs), such as a first EPRV 332 and a second EPRV 358. In some cases, the EPRVs 332, 358 can be solenoid actuators or other types of actuating devices. Further, the EPRVs 332, 358 may be used separately or together to actuate the ride control spool 306 between the various ride control positions, and the EPRVs 332, 358 may correspond to different ride control positions. For example, the first EPRV 332 can be used to actuate the ride control spool 306 between the first, second, third, and fourth ride control positions, while the second EPRV 358 can be used to actuate the ride control spool 306 between the first and fifth ride control positions. The EPRVs 332, 358, and thus the ride control spool 306, can be controlled by a controller 128 (e.g., an electronic controller), as illustrated in FIG. 12. That is, the controller 128 can selectively energize the EPRVs 332, 358 to overcome the biasing force of the biasing assembly 320 to move the ride control spool 306 between the various positions. The controller 128 can be a controller of the hydraulic machine (e.g., a controller that is used to operate the directional control valve 200), or another controller.

In some cases, the controller 128 can move the ride control spool 306 based on a sensed pressure of one or both of the actuator 114 and the accumulator 116. That is, the controller 128 can be configured to determine the pressure difference between the work port pressure and the accumulator pressure and to control the ride control spool 306 based on that determined pressure difference. Accordingly, the ride control system 100 can utilize the first sensor 122 to measure the work port pressure (i.e., the actuator pressure) and the second sensor 124 to measure the accumulator pressure. The controller 128 can receive a signal from each of the first sensor 122 and the second sensor 124, which can be used to determine the pressure difference between the work port pressure and the accumulator pressure.

With continued reference to FIG. 12, in some non-limiting examples, the main control valve 102 can include a low leak check valve 126 to reduce leakage from the actuator 114 to the main control valve 102, and thus, reduce actuator drift. By incorporating the ride control valve 300 into the main control valve 102, the low leak check valve 126 can be coupled along the work passage 312 between the work port 112 and the ride control spool 306. This differs from conventional arrangements that require external conduits to couple a ride control valve to an actuator, typically with the ride control spool and accumulator between the low leak check valve and the actuator 114. Correspondingly, the low leak check valve 126 arrangement as described herein, can reduce leakage to the ride control valve 300 to reduce actuator drift. In this way, the ride control valve 300 will have little to no effect on a leakage rate of the actuator 114. Additionally, this arrangement allows for wider manufacturing tolerances to be used without affecting system performance.

Moreover, the low leak check valve 126 has a side port 127 that is coupled with the work port 112 and the actuator 114, and a nose port 129 that is coupled with work passage 312 of the ride control valve 300 (e.g., to couple to the accumulator 116). A poppet 131 is movably disposed within a control chamber 133, which is coupled to the directional control spool 206 and/or the ride control spool via a control passage 350. Accordingly, when the directional control spool 206 is actuated to couple the pump 106 to the actuator 114, the pressure at the nose port 129 can exceed the pressure at the side port 127 (and within the control chamber 133) to open the poppet 131 and allow flow from the pump 106 to the work port 112 and actuator 114. When the directional control spool 206 is actuated to couple the actuator 114 to tank 110, the directional control spool 206 opens the control passage 350 to couple the control chamber 133 to the nose port 129, and the nose port 129 to the tank 110. As a result, the side port 127 pressure will be greater than both the nose port 129 and control chamber 133 pressures to cause the poppet 131 to open and allow flow from the actuator 114 to the tank 110.

Further, when the ride control spool 306 is in the first, second, and third ride control positions, the control passage 350 is blocked and the poppet 131 is closed to block the ride control spool 306 and accumulator 116 from the actuator 114. However, when the ride control spool 306 is in the fourth ride control position, the control passage 350 can be coupled with the nose port 129 via a check valve 344 or other type of non-return valve provided in the ride control valve 300. The check valve 344 allows the poppet 131 to open to allow bidirectional flow between the accumulator 116 and the actuator 114, thereby allowing movement of the actuator 114 when the ride control function is activated. In particular, when the nose port 129 pressure is greater than the side port 127 pressure, check valve 344 blocks flow from the nose port 129 to the control chamber 133, while the control passage 350 allows flow from the control chamber 133 to the side port 127, resulting in the control chamber 133 pressure being equal to the side port 127 pressure to allow the poppet 131 to open and allow flow from the accumulator 116 to the actuator 114. Conversely, when the side port 127 pressure is greater than the nose port 129 pressure, the pressure in control chamber 133 will be closer to the nose port 129 pressure and the poppet 131 will open to allow flow from actuator 114 to the accumulator 116. It is appreciated that the control chamber 133 pressure is closer to nose port 129 pressure because the pressure drop from side port 127 to the control chamber 133 across the control passage 350 will be higher than the pressure drop from control chamber 133 to the nose port 129. In some aspects, the check valve 344 is a dual-function valve that advantageously vents actuator pressure to the accumulator 116 when the ride control spool 306 is in the fourth ride control position and prevents backflow from the accumulator 116 to the pump 106, as will be discussed below in greater detail.

Referring now to FIGS. 12 and 13, and as discussed above, the accumulator 116 can store a pressurized volume of hydraulic fluid. The ride control valve 300, via movement of the ride control spool 306, can be configured to charge and discharge the accumulator 116 to store a volume of fluid at a desired pressure. Correspondingly, in some configurations, the ride control valve 300 may include a charge limit relief valve 336 and a max pressure relief valve 338 for the accumulator 116. The charge limit relief valve 336 may further set a desired charge pressure, as discussed below in greater detail. In some configurations, the accumulator 116 may discharge fluid to the tank 110 via the charge limit relief valve 336 when a charge limit pressure is achieved. Further, a pump compensator 346 can close the pump supply to the accumulator passage 318, and charge limit relief valve 336 flow to the tank 110 can be limited across a flow limiting orifice 341, thereby preventing excessive hydraulic power losses. In some examples, check valve 344 closes when the accumulator pressure is greater than the pump pressure. Additionally, the accumulator 116 may discharge fluid via the max pressure relief valve 338 to the tank 110 once a set maximum pressure is achieved in the accumulator 116. Accordingly, the max pressure relief valve 338 can be a direct-acting relief valve to prevent the accumulator 116 from over-pressurizing. Relatedly, the check valve 344 can prevent the accumulator 116 from discharging back to the pump 106 in addition to unlocking the low leak check valve 126 and allowing bidirectional flow between the actuator 114 and the accumulator 116, as discussed above. Relatedly, the check valve 344 can be positioned between the ride control spool 306 and the low leak check valve 126 such that the check valve 344 can inhibit flow from the ride control spool 306 to the control chamber 133 of the low leak check valve 126. In some aspects, the check valve 344 can be provided within the compensator 346, as illustrated in the non-limiting example.

Relatedly, it is generally preferable to match an accumulator pressure with the actuator pressure prior to activating the ride control function (e.g., by moving the ride control spool into the fourth position to couple the accumulator 116 to the actuator 114). For example, in some cases, the ride control system 100 may be configured to block the ride control spool 306 from moving to the fourth position (e.g., via operation of the controller 128) unless a pressure difference between the work passage 312 (e.g., the work port 112) and the accumulator passage 318 is less than a predetermined pressure differential (e.g., about 3 bar to about 5 bar, or another pressure value).

To balance the accumulator pressure with the actuator pressure, the ride control valve 300 can include a pressure balancing spool 400 configured to selectively couple the accumulator 116 to the pump 106 and the tank 110 (e.g., via their respective passages in the ride control valve 300). Specifically, the pressure balancing spool 400 can accomplish the above function by moving between two positions, namely, a first balancing position and a second balancing position. However, it is appreciated that the pressure balancing spool 400 is selectively coupled with the pump 106, tank 110, and accumulator 116 via the ride control spool 306, and thus flow through the pressure balancing spool 400 may be dependent on a position of the ride control spool 306. Thus, it will be understood that the pressure balancing spool 400 may selectively couple components of the ride control system 100 to one another in different configurations at different ride control positions, even if the pressure balancing spool 400 is held at a balancing position (i.e., one of the first or second balancing positions mentioned below). Thus, any reference herein to the “first balancing position” and the “second balancing position” will be understood as being dependent on a position of the ride control spool 306.

Still referring to FIGS. 12 and 13, the pressure balancing spool 400 can be configured as a single-biased valve that can move between the first and second balancing positions based on a pressure differential between the work passage 312 and the accumulator passage 318, and/or a desired charge limit pressure that is set or defined by the charge limit relief valve 336. More specifically, the pressure balancing spool 400 can include a biasing assembly 420 configured to bias the pressure balancing spool 400 into the first balancing position when a pressure difference between the work passage 312 and the accumulator passage 318 is less than a predetermined pressure differential and/or less than the desired charge limit pressure. To accomplish this, the biasing assembly 420 includes a compliant member 422 (e.g., a balancing spring or other type resilient member), as illustrated in FIG. 13. It is appreciated that the predetermined pressure differential can be set based on a spring installed force of the balancing spring 422. Further, the predetermined pressure differential can act to provide hysteresis to the ride control system 100 that can reduce rapid changes in position of the pressure balancing spool 400, which may occur due a load on the actuator 114 being varied.

Due to the biasing spring force provided by the balancing spring 422, the biasing assembly 420 generally biases the pressure balancing spool 400 into the first balancing position when the pressure difference between the work passage 312 and the accumulator passage 318 is less than the predetermined pressure differential. However, when the pressure difference between the work passage 312 and the accumulator passage 318 is greater than or equal to the predetermined pressure differential, the pressure difference can generally overcome the biasing spring force of the balancing spring 422 and move the pressure balancing spool 400 to the second balancing position. In other non-limiting examples, a biasing assembly can be arranged in other ways. For example, a biasing assembly can include multiple compliant members that may be arranged opposite, in parallel with, or in series with one another. Further, movement of the pressure balancing spool 400 can result from connecting opposing ends thereof to different passages in the ride control valve 300, as will be discussed below in greater detail.

As discussed above, the ride control valve 300 can include the check valve 344 to prevent flow to the pump 106 in the first and second balancing positions (e.g., when balancing the accumulator pressure with the pump 106 “off” or supplying fluid at a lower pressure than that of the accumulator 116). In some aspects, the check valve 344 can be positioned along the pump passage 304, between the pressure balancing spool 400 and the ride control spool 306 (e.g., the pump 106), and/or internal to the compensator 346, which can reduce a pump pressure to a predetermined margin greater than the accumulator pressure. In the illustrated non-limiting example, the check valve 344 is internal to the compensator 346, and the compensator is positioned between the accumulator 116 and the pressure balancing spool 400. More specifically, the compensator 346 can be positioned along the pump passage 304, between the pressure balancing spool 400 and the ride control spool 306 (e.g., the pump 106), and/or between the accumulator passage 318 and the pressure balancing spool 400. Moreover, the compensator 346 can be selectively coupled to the accumulator 116 via the accumulator passage 318, and to the ride control spool 306 via the second pump passage 304B.

In some examples, the compensator 346 may be provided to sense a valve load-sensing (LS) pressure of the system, which can allow the compensator 346 can be used to control a flow rate across the ride control spool 306, e.g., to maintain pump margin across the pressure balancing spool 400 and prevent excessive flow into the accumulator 116. For example, the compensator 346 may be coupled to an LS passage 434 defined in the valve body 302 that causes the compensator 346 to selectively close due to the (LS) pressure. Specifically, the compensator 346 may increasingly restrict flow from the second pump passage 304B to the accumulator passage 318 until a pressure in the second pump passage 304B is balanced with, i.e., substantially equal to, the LS pressure. In this way, the compensator 346 can act as a post-compensator that can be configured to optimize the allocation of pump flow by allowing pump flow to be shared with multiple functions within the ride control system 100.

In some cases, the pressure balancing spool 400 can be advantageously arranged relative to the ride control spool 306 to provide more compact packaging and to allow the ride control function to be operated using a single EPRV. For example, with continued reference to FIG. 13, the pressure balancing spool 400 can be movable relative to, and secured within, the ride control spool 306. That is, the pressure balancing spool 400 can be movably disposed within a chamber 348 (e.g., a bore) that is defined within the ride control spool 306 (e.g., to be nested within the ride control spool 306). More specifically, the pressure balancing spool 400 and the ride control spool 306 can be coaxial with one another, such that each can move along an axis 360 between their respective positions. In other non-limiting examples, the pressure balancing spool 400 can be arranged differently, for example, to be spaced apart from the ride control spool 306 while remaining within the ride control valve 300. Correspondingly, the biasing assembly 420 can also be disposed within the ride control spool 306 to bias the pressure balancing spool 400 relative to and within the ride control spool 306. In particular, the balancing spring 422 can be positioned to apply a biasing force between a first end 430A of the pressure balancing spool 400 and the ride control spool 306. In this case, the balancing spring 422 can retained on the pressure balancing spool 400 by a first retainer. In other non-limiting examples, the biasing assembly 420 can be arranged differently (e.g., arranged with multiple compliant members and/or retaining members).

Referring again to FIG. 6, a method 600 for controlling a ride control valve for a hydraulic machine is illustrated. While the method 600 is described with reference to the ride control system 100 of FIGS. 12 and 13, it is understood that the method 600 can also be used with other non-limiting examples of ride control systems. Further, it is appreciated that various steps of the method 600 do not need to be carried out in any particular order.

As generally mentioned above, the controller 128 can selectively energize the EPRVs 332, 358 to move the ride control spool 306 between the plurality of ride control positions. In particular, at block 604, the ride control spool 306 can be positioned in the first ride control position. The first ride control position can correspond with an “off” or deactivated state of the ride control valve 300. Specifically, and with additional reference to FIG. 13, the controller 128 can energize the first EPRV 332, the second EPRV 358, or both to position the ride control spool 306 in the first ride control position, for example, by applying a first electrical current to the first EPRV 332 and/or the second EPRV 358. The first electrical current can be a range of electrical currents configured to axially position the ride control spool 306 to discharge the accumulator 116 (e.g., between about 0 milliamperes and about 400 milliamperes, or between about 0 milliamperes and about 250 milliamperes). In some cases, the first electrical current may be zero milliamperes, such that the controller 128 de-energizes the EPRVs 332, 358. That is, because the ride control spool 306 can be biased to the first ride control position by the biasing assembly 320, the controller 128 may not energize the EPRVs 332, 358 to allow the biasing assembly 320 to apply a force to the ride control spool 306 and retain it in the first ride control position.

As generally mentioned above, in the first ride control position, the accumulator 116 is coupled to discharge to the tank 110, and the accumulator 116 can be blocked from both the pump 106 and the actuator 114. In the first ride control position, the first, second, and third control springs 322, 324, 325 can each be in a preloaded or uncompressed state, such that the ride control spool 306 is spaced from the first spool seat 328 by a first distance. Accordingly, the first, second and third control springs 322, 324, 325 can each be at a respective preloaded or initial spring length. The first control spring 322 can extend between the first spring seat 326 and the seat member 331 and/or the first spool seat 328. Relatedly, the ride control spool 306 can be spaced from the third spool seat 354 that is defined by the second end 333B of the valve body 302, and the seat member 331 can be spaced from the second spool seat 330. With regard to the actuator 114, the low leak check valve 126 can be closed so that the ride control valve 300 does not contribute to the leakage rate of the actuator 114. Relatedly, in the first position, the pressure balancing spool 400 can be vented to the tank 110 so that the pressure balancing spool 400 is in the first balancing position.

At block 606, and with reference to FIGS. 6, 14, and 15, the ride control spool 306 can be positioned in the second ride control position. The second ride control position can correspond with a charging state of the ride control valve 300 that is configured to supply fluid to increase the pressure of the accumulator 116 (e.g., to charge the accumulator 116). The controller 128 can selectively energize the first EPRV 332 to axially position the ride control spool 306 at the second ride control position. For example, the controller 128 can provide a second electrical current value to the first EPRV 332, and the second electrical current can be a range of electrical currents configured to axially position the ride control spool 306 to charge the accumulator 116 (e.g., between about 500 milliamperes and about 900 milliamperes, or between about 250 milliamperes and about 450 milliamperes).

As generally mentioned above, the second ride control position can be a variable position to allow a charging flow rate of the accumulator 116 to be adjusted between a minimum and a maximum charging flow rate. Accordingly, the second position can include a range of axial positions that block the tank passage 308 and the work passage 312 and couple the accumulator passage 318 to the pump passage 304. In the illustrated non-limiting example, the controller 128 can operate under a proportional control mode to vary an electrical current supplied to the first EPRV 332 to adjust the ride control spool 306 with the range of axial positions to vary an open area between the accumulator passage 318 and pump passage 304. By controlling the size of the open area, the charging flow rate of the accumulator 116 is also controlled.

In the second ride control position, the ride control spool 306 is moved toward the first spool seat 328 and the second spool seat 330. More specifically, the ride control spool 306 remains spaced from the first spool seat 328 by a second distance that is less than the first distance, and the first spool seat 328 remains spaced from the second spool seat 330. In doing so, the first spring seat 326 can engage and move with the ride control spool 306 to compress the first control spring 322 between the first spring seat 326 and the first spool seat 328, or between the first spring seat 326 and the pin 335, such that the first control spring 322 is at a second spring length (e.g., an intermediate spring length). It is appreciated that the second control spring 324 and/or the third control spring 325 may remain at about their respective maximum lengths (e.g., to be substantially uncompressed (e.g., a preloaded condition) as compared with the first ride control position). More specifically, due to the higher preload on the second control spring 324 and the third control spring 325, the second control spring 324 and the third control spring 325 will not further compress in the second ride control position and will remain at its preloaded length.

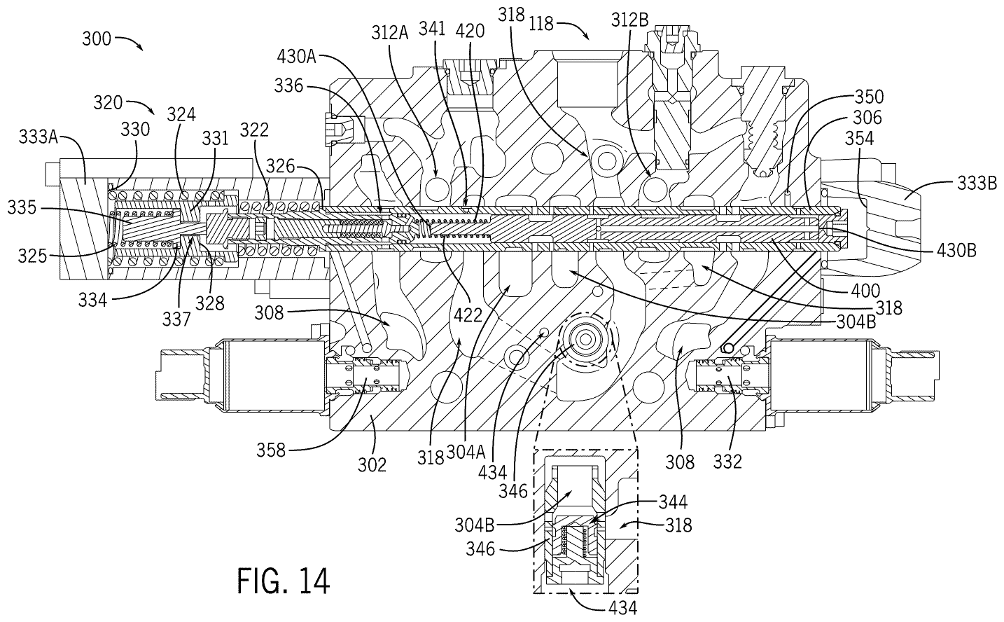

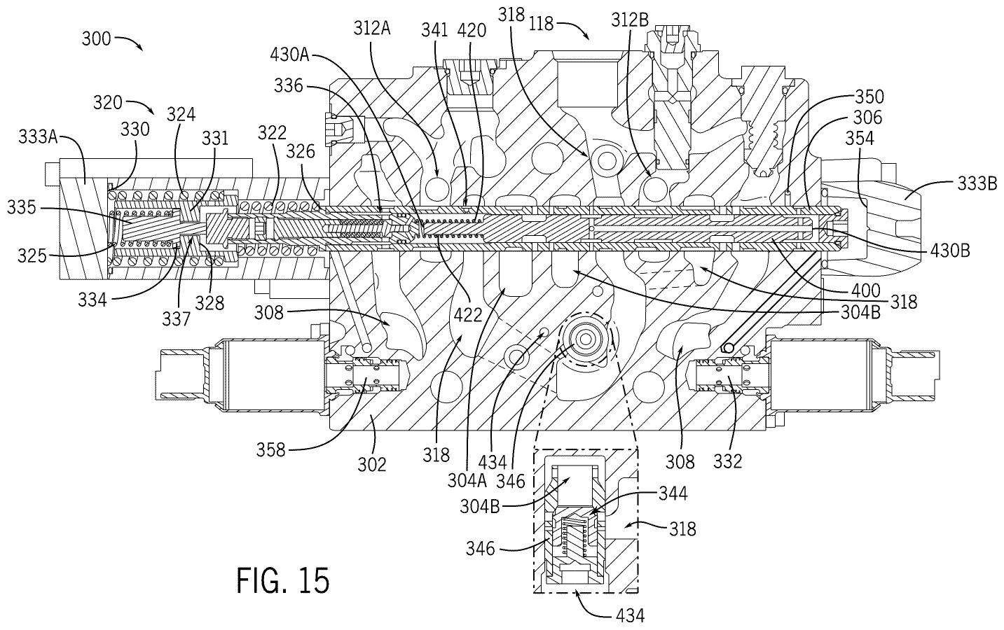

With regard to the actuator 114, the low leak check valve 126 is closed so that the ride control valve 300 does not contribute to the leakage rate of the actuator 114. Relatedly, in the second ride control position, the pressure balancing spool 400 can be movable between a first balancing position (see FIG. 14) and a second balancing position (see FIG. 15) to selectively couple the accumulator passage 318 to the pump passage 304, within the ride control spool 306. For example, the pressure balancing spool 400 can be biased (e.g., via the biasing assembly 420) into the first balancing position when the accumulator pressure is less than the charge limit pressure defined by the charge limit relief valve 336, and into the second balancing position when the accumulator pressure is greater than or equal to the charge limit pressure. Specifically, in the first balancing position, illustrated in FIG. 14 (e.g., a charging position), the pressure balancing spool 400 can connect the accumulator 116 to the pump 106 by blocking the tank passage 308 and coupling the accumulator passage 318 to the pump passage 304. As a result, high pressure fluid from the pump 106 will flow to the accumulator 116 to pressurize and charge the accumulator 116. In some aspects, fluid is provided from the pump 106 to the accumulator 116 via the compensator 346, meaning that the check valve 344 allows unidirectional flow from the pump 106 to the accumulator 116. In the second balancing position, as illustrated in FIG. 15, (e.g., a holding position) the pressure balancing spool 400 can be actuated to disconnect the pump 106 from the accumulator 116 by blocking the pump passage 304, thereby maintaining the charged pressure in the accumulator 116.

This movement of the pressure balancing spool 400 can result from a pressure differential between the ends 430 of the pressure balancing spool 400, which can each be coupled to the accumulator passage 318 in the second ride control position. As discussed above, the charge limit relief valve 336 can open when the desired charge pressure that is set by the charge limit relief valve 336 is reached. It will be understood that the desired charge pressure may be greater than the actuator pressure, meaning that the accumulator pressure may also be greater than the actuator pressure when the desired charge pressure is reached. Opening the charge limit relief valve 336 can restrict flow to the first end 430A of the pressure balancing spool 400 by directing flow through the flow limiting orifice 341. This restricted flow can limit the pressure at the first end 430A, which in turn can cause the pressure at the second end 430B to become greater than the pressure at the first end 430A. After this pressure differential reaches a predetermined value (i.e., the predetermined pressure differential set by the spring installed force of the balancing spring 422), the higher pressure at the second end 430B relative to the first end 430A can cause the pressure balancing spool 400 to move from the first balancing position to the second balancing position. It will be understood that the desired charge pressure set by the charge limiting relief valve 336 may be greater than a cracking or setpoint pressure of the charge limiting relief valve 336 by a predetermined pressure differential to account for the preload of the balancing spring 422. In some examples, the preload of the balancing spring 422 can cause the predetermined pressure differential to be between about 1 bar and about 10 bar, or about 5 bar.

At block 608, and with reference to FIGS. 6, 16, and 17, the ride control spool 306 can be positioned in the third ride control position. The third ride control position can correspond with balancing state of the ride control valve 300 that is configured to match the accumulator pressure with the actuator pressure. That is, the ride control valve 300 can charge and discharge the accumulator 116 to bring the accumulator pressure within a predetermined pressure differential from the actuator pressure. Accordingly, the controller 128 can energize the first EPRV 332 to axially position the ride control spool 306 at the third ride control position. For example, the controller 128 can provide a third electrical current value to the first EPRV 332. The third electrical current can be a range of electrical currents configured to axially position the ride control spool 306 to balance the accumulator pressure with the actuator pressure (e.g., between about 1000 milliamperes and about 1250 milliamperes, or between about 500 milliamperes and about 600 milliamperes).

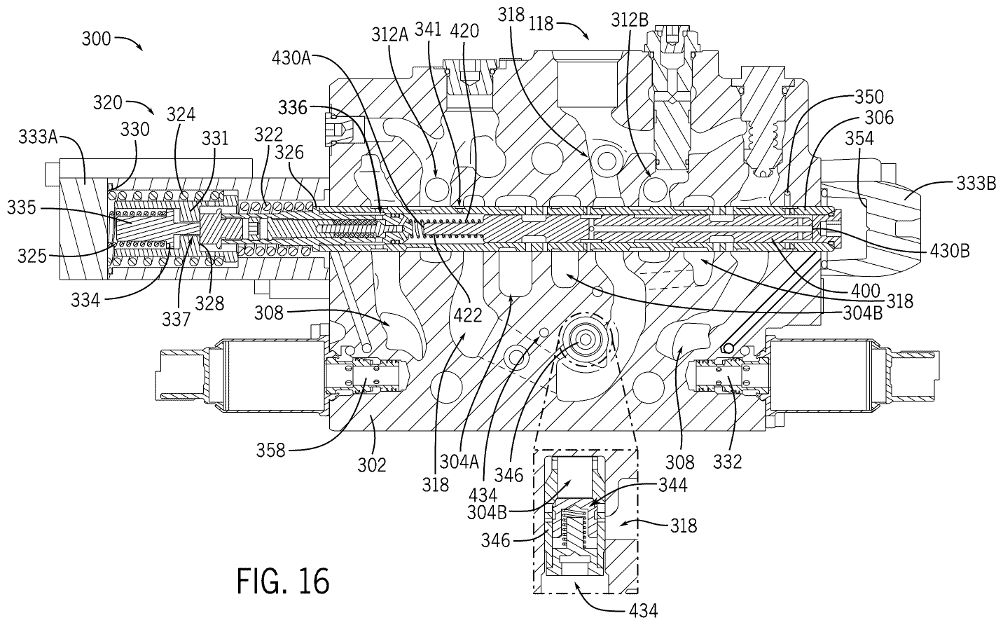

Referring now to FIG. 16, in the third ride control position, the ride control spool 306 is moved toward the first spool seat 328 and the second spool seat 330 so that the work passage 312 is blocked, and the accumulator passage 318 can be selectively coupled with the tank passage 308 via the pressure balancing spool 400. More specifically, the ride control spool 306 is moved into contact with the first spool seat 328, while the seat member 331 remains spaced from the second spool seat 330. In doing so, the first spring seat 326 moves with the ride control spool 306 to further compress the first control spring 322 between the first spring seat 326 and the first spool seat 328, such that the first control spring 322 is at a third spring length (e.g., minimum spring length) that is less than both the first spring length and the second spring length, as discussed above. It is appreciated that, due to the higher initial preload of the second control spring 324, the second control spring 324 does not compress, such that the first spool seat 328 can function similarly to a hard or immovable seat in the third ride control position. However, because the ride control spool 306 is in contact with the first spool seat 328, the pin 335 can be moved further toward the second spool seat 330. Correspondingly, the second spring seat 334 moves with the pin 335 to compress the third control spring 325 between the second spool seat 330 and the second spring seat 334, such that the third control spring 325 is at a second compressed length relative to its non-compressed length defined in the first and second ride control positions (see FIGS. 13 and 14). In this way, the biasing force provided by the biasing assembly 320 can be increased relative to a biasing assembly consisting of a single spring, thus allowing the ride control spool 306 to be more precisely actuated into the third ride control position, as discussed above.

With the ride control spool 306 in the third ride control position, the first end 430A of the pressure balancing spool 400 can be coupled to the accumulator passage 318 and the second end 430B of the pressure balancing spool 400 opposite the first end 430A can be coupled to the actuator 114, via the side port 127, the control chamber 133, and the control passage 350, to provide pressure compensation for the biasing assembly 420. Accordingly, when the accumulator pressure is greater than the actuator pressure by the predetermined pressure differential, the pressure balancing spool 400 can move to the first balancing position to discharge and depressurize accumulator 116, as illustrated in FIG. 16. Relatedly, the check valve 344 within the compensator 346 prevents backflow to the pump 106, thereby ensuring that depressurization is properly conducted via the tank 110.

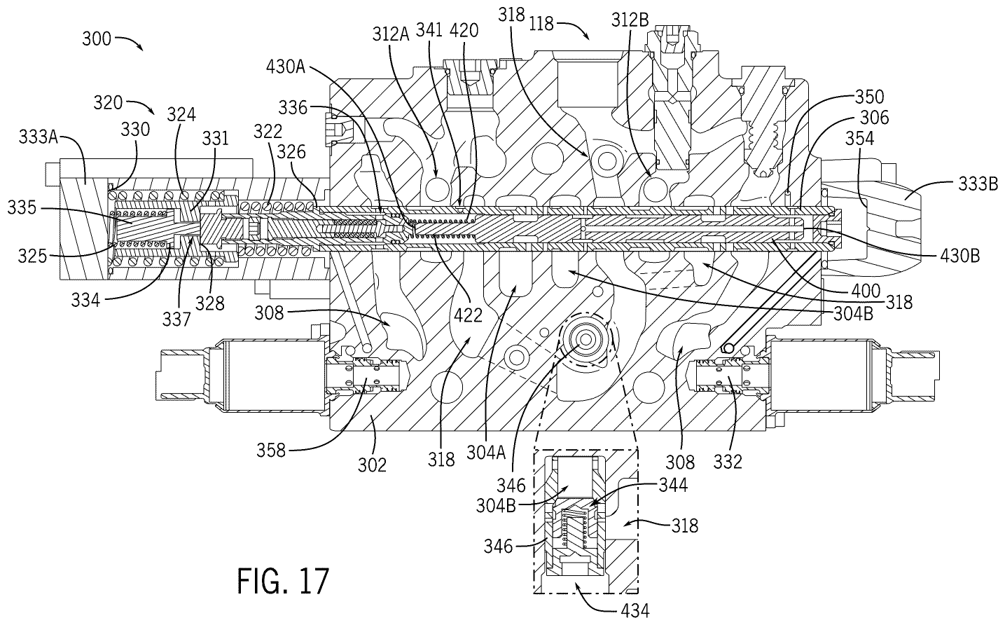

Referring now to FIG. 17, when the actuator pressure is greater than the accumulator pressure by the predetermined pressure differential, the pressure balancing spool 400 can move to the second balancing position to maintain the accumulator pressure within the predetermined pressure differential from the actuator pressure. In particular, the pressure balancing spool 400 can decouple the accumulator 116 from the tank port 108 by blocking flow from the accumulator passage 318 to the tank passage 308 in the second balancing position. The pressure balancing spool 400 can move independently of the ride control spool 306, such that the pressure balancing spool 400 moves between the first and second balancing positions, while the ride control spool 306 can remain stationary in the third ride control position. Further, it will be understood that the pressure balancing spool 400 can be normally biased into the first balancing position via the balancing spring 422. In some aspects, the predetermined pressure threshold corresponds to the biasing force provided by the balancing spring 422. For example, the predetermined pressure threshold may be between about 1 bar and about 10 bar, or between about 3 bar and about 10 bar, or between about 3 bar and about 5 bar, or about 3 bar. That is, the pressure balancing spool 400 can move from the first balancing position to the second balancing position when the accumulator pressure is less than or equal to the predetermined pressure threshold subtracted from the actuator pressure. In this way, a desired accumulator pressure can be precisely charged and maintained.

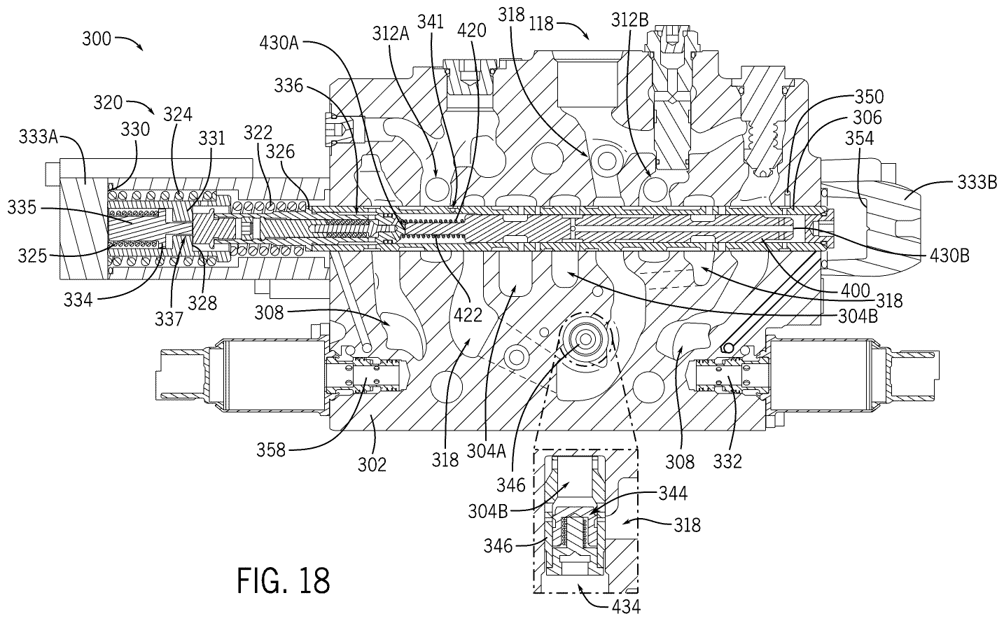

At block 610, and with reference to FIGS. 6 and 18, the ride control spool 306 can be positioned in the fourth ride control position. The fourth ride control position can correspond with an activated state of the ride control valve 300 that is configured to activate the ride control function by coupling the actuator 114 with the accumulator 116. Accordingly, the controller 128 can energize the first EPRV 332 to axially position the ride control spool 306 at the fourth ride control position. For example, the controller 128 can provide a fourth electrical current value to the first EPRV 332. The fourth electrical current can be a range of electrical currents configured to axially position the ride control spool 306 to couple the accumulator 116 to the actuator 114 (e.g., greater than about 1300 milliamperes, or greater than about 650 milliamperes). In some cases, the fourth current command can be a 100% current command, whereas the first, second, and third current commands can be proportionally lesser commands (e.g., between about 0% and about 35%, between about 30% and about 65%, and between about 50% and about 90%, respectively).

In some cases, the controller 128 may be configured to move the ride control spool 306 to the fourth position when the pressure difference between the accumulator 116 and the actuator 114 is less than the predetermined pressure differential (e.g., the biasing force of the balancing spring 422). Correspondingly, the controller 128 can be configured to determine the pressure difference between the work port pressure and the accumulator pressure (e.g., based on a signal from each the first sensor 122 and the second sensor 124). In the fourth ride control position, the ride control spool 306 is moved toward the first spool seat 328 and the second spool seat 330 so that the tank passage 308 and the pump passage 304 are blocked, and the accumulator passage 318 is coupled with the second work passage 312B. More specifically, the ride control spool 306 is moved to cause the seat member 331 to move into contact with the second spool seat 330. This causes the second control spring 324 to be fully compressed between the first spool seat 328 and the second spool seat 330, and further, causes the third control spring 325 to be further compressed between the second spool seat 330 and the second spring seat 334. Put another way, moving the ride control spool 306 to cause the seat member 331 to move into contact with the second spool seat 330 can cause the second control spring 324 and the third control spring to be compressed in parallel with one another.

Relatedly, the pressure balancing spool 400 can move within the ride control spool 306 to block the tank passage 308 and the pump passage 304. In particular, the first end 430A of the pressure balancing spool 400 can be coupled to the first work passage 312A, which can be coupled to the tank 110 as discussed above. That is, the ride control spool 306 can couple the actuator 114 to the tank 110 via the first work passage 312A in the fourth ride control position. Further, the second end 430B of the pressure balancing spool 400 can be coupled to the actuator 114 via the control passage 350 to bias pressure balancing spool 400 into the second balancing position while the ride control spool 306 is in the fourth ride control position. Additionally, the accumulator 116 will be coupled with the actuator 114 via the low leak check valve 126, which, as generally described above, can allow fluid to flow between the actuator 114 and the accumulator 116 in response to fluctuating actuator pressures caused by, for example, the hydraulic machine traveling along an uneven support surface. That is, the low leak check valve 126 can allow for bi-directional flow between the actuator 114 and the accumulator 116. In some examples, the check valve 344 can selectively inhibit flow from the accumulator 116 to the control chamber 133 of the low leak check valve 126 when the ride control spool 306 is in the fourth ride control position.

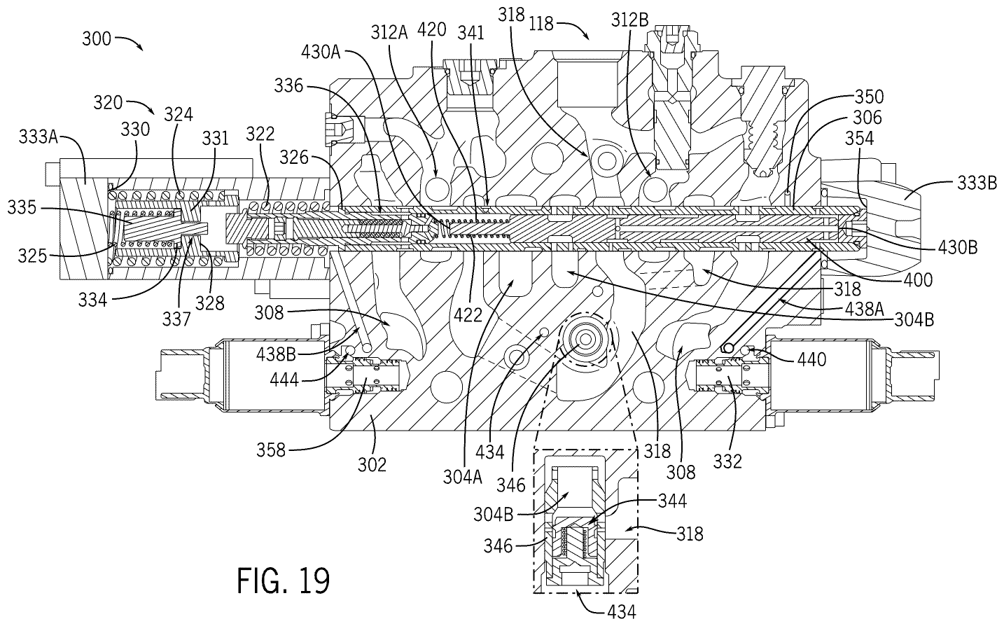

Referring now to FIGS. 6 and 19, in some non-limiting examples, the ride control valve 300 can also be configured to provide a warm-up function. That is, at block 602, the ride control spool 306 can be positioned in the fifth ride control position. The fifth ride control position can correspond with a warm-up state of the ride control valve 300 that is configured to allow fluid to circulate through the system. Accordingly, the controller 128 can selectively actuate the first EPRV and the second EPRV 358 to axially position the ride control spool 306 at the fifth ride control position. In some examples, the second EPRV 358 can be energized and the first EPRV 332 can be deenergized to position the ride control spool 306 at the fifth ride control position, such that the warm-up function can be operated independently of the directional control valve 200 or other functions (e.g., a ride control or other function). For example, the controller 128 can provide an electrical current value to the second EPRV 358. The electrical current can be a range of electrical currents configured to axially position the ride control spool 306 to couple the pump 106 to the tank 110 (e.g., between about 250 milliamperes and about 1500 milliamperes, or between about 125 milliamperes and about 750 milliamperes). In the fifth ride control position, the ride control spool 306 is moved axially away from the first, second, third, and fourth ride control positions, such that the ride control spool 306 contacts the third spool seat 354. Correspondingly, the second control spring 324 and the third control spring 325 can relax to their respective non-compressed lengths.

In the fifth ride control position, the ride control valve 300 can be configured to couple the pump 106 directly to the tank 110, via the ride control spool 306, to allow hydraulic fluid to circulate through the ride control valve 300 and other system components to warm the system to a desired operating temperature. More specifically, the ride control valve 300 can allow a proportional, limited, and compensated flow from the pump passage 304 to the tank passage 308 in the fifth ride control position. Further, the ride control valve 300 can provide pilot-to-sump and tank-to-sump connections on opposite sides of the ride control valve 300 in the fifth ride control position. Specifically, warm-up flow through a first pilot passage 438A and a first sump passage 440 is provided through the first EPRV 332 to the second end 333B of the valve body 302, and warm-up flow through a second pilot passage 438B, a second sump passage 444, and a restriction orifice 362 between the second EPRV 358 output and the second sump passage 444 can be provided through the second EPRV 358 to the first end 333A of the valve body 302. In this way, pilot-to-sump and tank-to-sump connections are provided at either end of the valve body 302. Accordingly, the above connections can be used to warm the main control valve 102 and the system hydraulic fluid to a desired operating temperature. In some cases, the pump 106 can be coupled to the compensator 346, which can provide a restriction to cause heating of the fluid. Further, coupling the pump 106 to the compensator 346 can help to maintain pump margin across the ride control spool 306, e.g., between the first pump passage 304A and the second pump passage 304B. This in turn can allow warm-up flow to be shared with other functions of the ride control valve 300, meaning that the ride control valve 300 can provide warm-up flow within the ride control system 100, e.g., additional components of the ride control system 100, while other functions of the ride control valve 300 are being actuated. Additionally, in the fifth ride control position, the accumulator passage 318 can be coupled to the tank passage 308, while the work passage 312, e.g., the first work passage 312A and the second work passage 312B, is blocked.

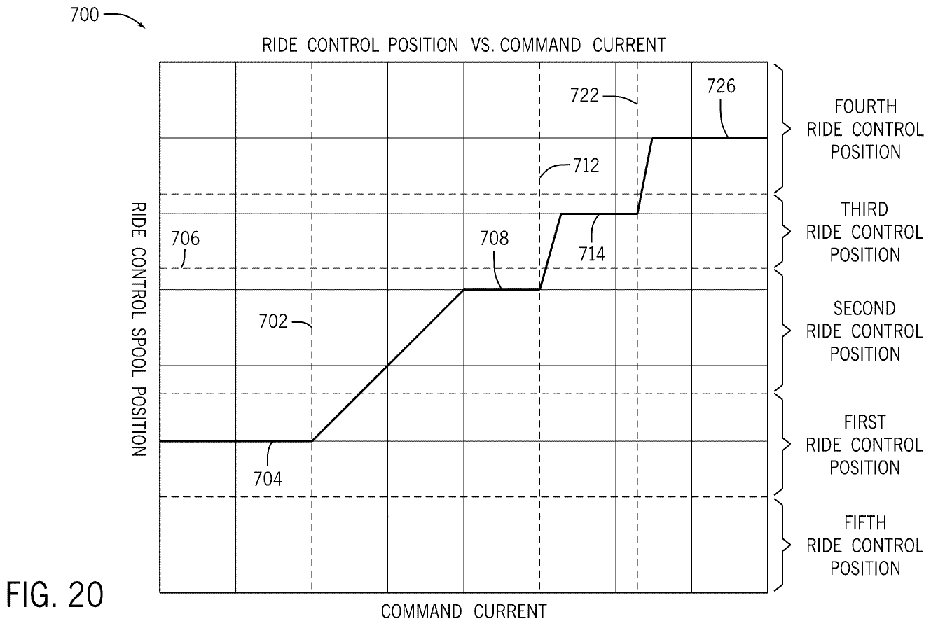

FIG. 20 illustrates the relationship between the ride control position of the ride control spool 306 and the command current delivered to the EPRVs 332, 358. As generally mentioned above, in the first ride control position, the first control spring 322 can be preloaded. In the first ride control position, the first control spring 322 may be preloaded so that the first control spring 322 does not further compress unless acted upon by a first threshold compression force. In some non-limiting examples, the first EPRV 332 may begin to compress the first control spring 322 by overcoming the first threshold compression force, for example, once a first threshold current energizes the first EPRV 332. Energizing current supplied to the first EPRV 332 that is greater than the first threshold current can cause the first EPRV 332 to displace the ride control spool 306 from the first ride control position, through the second ride control position, and to the third ride control position. In some non-limiting examples, the ride control spool 306 may be displaced from the first to the fourth ride control position, proportionally to the current supplied to the first EPRV 332 in excess of the first threshold current.

Still referring to FIG. 20, similar to the first control spring 322, the second and third control springs 324, 325 can be preloaded so that the second and third control springs 324, 325 are not further compressed unless acted upon by a second threshold compression force and/or a third threshold compression force, respectively. The second and/or third threshold compression forces can be greater than the first threshold compression force, such that the first control spring 322 may be partially compressed without compression of the second or third control springs 324, 325. Additionally, the third threshold compression force can be greater than the second threshold compression force, such that the third control spring 325 may be partially compressed without compression of the second control spring 324. The ride control spool 306 may therefore not be actuated from the third ride control position to the fourth ride control position until the second and/or third threshold compression forces of the second and third control springs 324, 325, respectively, are overcome. Correspondingly, the first EPRV 332 may begin to compress the second and third control springs 324, 325 by overcoming the second and/or third threshold compression forces, for example, once a second threshold current energizes the first EPRV 332. Energizing current supplied to the first EPRV 332 that is greater than the second threshold current can cause the first EPRV 332 to displace the ride control spool 306 from the third ride control position, or any other ride control position, to the fourth ride control position. In some non-limiting examples, the ride control spool 306 may be displaced from the third to the fourth ride control position, proportionally to the current supplied to the first EPRV 332 in excess of the second threshold current.

Accordingly, and as illustrated in the non-limiting example plot 700 of ride control position and command current of FIG. 20, to move the ride control spool 306 from the first ride control position to the third ride control position, the controller 128 can supply a first threshold current 702 to overcome the preload of the first control spring 322 and initially move the ride control spool 306 from the first ride control position (e.g., at line 704), toward the second ride control position. Subsequently, increasing the command current that is supplied to the first EPRV 332 moves the ride control spool 306 from the first ride control position, through the second ride control position (e.g., at line 706), at a first proportional rate until the ride control spool 306 contacts the pin 335 to partially compress the first control spring 322 and achieve the second ride control position (e.g., at line 708). At this point, further movement of the ride control spool 306 toward the third ride control position is resisted by the second and third control springs 324, 325 until a second threshold current 712 is supplied. Once the second threshold current 712 is supplied, a further increase in the current moves the ride control spool 306 from the second ride control position at a second proportional rate until the ride control spool 306 contacts the seat member 331 to fully compress the first control spring 322 and partially compress the third control spring 325 and achieve the third ride control position (e.g., at line 714). At this point, further movement of the ride control spool 306 toward the fourth ride control position is resisted by the second and third control springs 324, 325 until a third threshold current 722 is supplied. Once the third threshold current 722 is supplied, a further increase in the current moves the ride control spool 306 from the third ride control position at a third proportional rate until the seat member 331 contacts the second spool seat 330 to fully compress the second and third control springs 324, 325 and achieve the fourth ride control position (e.g., at line 726). In some examples, the third proportional rate is greater than the second proportional rate, or the second and third proportional rates are about equal with one another.

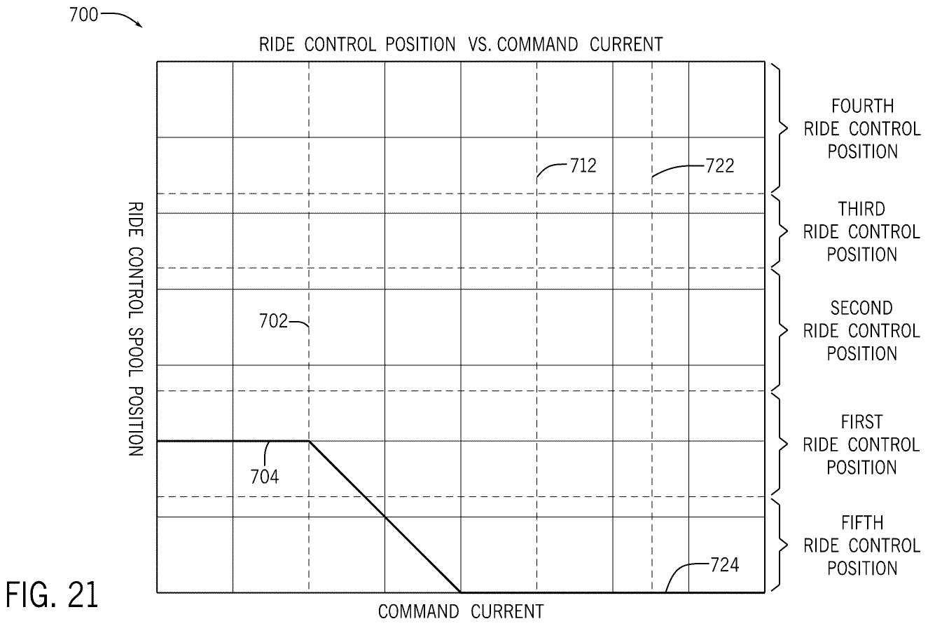

Further, and as illustrated in the non-limiting example plot 800 of ride control position and command current of FIG. 21, to move the ride control spool 306 from the first ride control position to the fifth ride control position, the controller 128 can supply a third threshold current 702 to the second EPRV 358 and move the ride control spool 306 from the first ride control position (e.g., at line 704) at a fourth proportional rate until the ride control spool 306 contacts the third spool seat 354 and compresses the first control spring 322 to achieve the fifth ride control position (e.g., at line 724). In some examples, the fourth proportional rate is about equal to the first proportional rate at which the ride control spool 306 is moved from the first ride control position to the second ride control position, as discussed above. It is contemplated that the ride control spool 306 may move in an opposite direction to achieve the fifth ride control position that the direction the control spool 306 moves to achieve the second, third, and fourth ride control positions. Thus, and as discussed above, the ride control valve 300 is actuated between the various ride control positions by selectively supplying energizing currents to the EPRVs 332, 358. In particular, supplying energizing currents to the EPRVs 332, 358 can allow pilot flow therethrough to selectively actuate the ride control valve 300 between the various ride control positions. Accordingly, the ride control valve 300 may also be selectively actuated into the fifth ride control position from the first, second, third, and fourth ride control positions.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

What is claimed is:

1. A ride control system for a hydraulic machine having a pump, an actuator, and a tank, the ride control system comprising:
an accumulator; and
a control valve having a work port configured to couple to the actuator, a pump port configured to couple to the pump, and a tank port configured to couple to the tank, and an accumulator port configured to couple to the accumulator, the control valve including:
a directional control valve configured to selectively couple the work port, the pump port, and the tank port to operate the actuator; and
a ride control valve including:
a valve body;
a ride control spool movably disposed within the valve body, the ride control spool configured to selectively couple the work port, the tank port, the pump port, and the accumulator; and
a pressure balancing spool movably disposed within the valve body, the pressure balancing spool configured to selectively couple the accumulator with the pump port and the tank port,
wherein the ride control spool is configured to move between each of:
a first ride control position configured to couple the accumulator with the tank port to discharge the accumulator;
a second ride control position configured to selectively couple the pump port to the accumulator to charge the accumulator;
a third ride control position configured to selectively couple the tank port to the accumulator to balance an accumulator pressure of the accumulator with a work port pressure of the work port;
a fourth ride control position configured to couple the accumulator to the work port; and
a fifth ride control position configured to couple the accumulator with the pump port and the tank port to heat fluid in the hydraulic machine to an operating temperature.

2. The ride control system of claim 1, wherein the second ride control position is an infinitely variable position, in which the ride control spool moves between the first ride control position and the third ride control position to vary a charging rate of the accumulator.

3. The ride control system of claim 1, wherein when the ride control spool is in the second ride control position, the pressure balancing spool is movable between each of:
a first balancing position configured to couple the pump port to the accumulator to charge the accumulator; and
a second balancing position configured to decouple the accumulator from the pump port.

4. The ride control system of claim 3, wherein the pressure balancing spool includes a biasing assembly configured to bias the pressure balancing spool into the first balancing position when the accumulator pressure is less than a charge limit pressure defined by a charge limit relief valve; and
wherein the pressure balancing spool is biased to the second balancing position when the accumulator pressure is greater than or equal to the charge limit pressure.

5. The ride control system of claim 1, wherein when the ride control spool is in the third ride control position, the pressure balancing spool is movable between each of:
a first balancing position configured to couple the accumulator to the tank port to discharge the accumulator; and
a second balancing position configured to decouple the accumulator from the tank port.

6. The ride control system of claim 5, wherein the pressure balancing spool includes a biasing assembly configured to bias the pressure balancing spool into the first balancing position when the accumulator pressure is greater than the work port pressure by at least a first predetermined pressure differential; and
wherein the pressure balancing spool is biased to the second balancing position when the work port pressure is greater than the accumulator pressure by at least a second predetermined pressure differential.

7. The ride control system of claim 1, wherein the ride control valve further includes a first electrohydraulic pressure regulating valve configured to move the ride control spool from the first ride control position to each of the second ride control position, the third ride control position, and the fourth ride control position.

8. The ride control system of claim 7, further including a controller configured to energize the first electrohydraulic pressure regulating valve to move the ride control spool.

9. The ride control system of claim 8, wherein the controller is configured to energize the first electrohydraulic pressure regulating valve to move the ride control spool from the third ride control position to the fourth ride control position when a pressure difference between the work port pressure and the accumulator pressure is within a predetermined pressure differential.

10. The ride control system of claim 9, wherein the controller is configured to determine the pressure difference between the work port pressure and the accumulator pressure based on a first sensor configured to measure the work port pressure and a second sensor configured to measure the accumulator pressure.

11. The ride control system of claim 7, wherein the ride control valve includes a second electrohydraulic pressure regulating valve configured to move the ride control spool from the first ride control position to the fifth ride control position.

12. The ride control system of claim 1, wherein the ride control valve further includes a check valve disposed within a compensator to prevent fluid flow from the accumulator to the pump port when the ride control valve is in the second ride control position.

13. The ride control system of claim 1, wherein the control valve further includes:
a low leak check valve configured to selectively couple the work port to the accumulator; and
a check valve configured to selectively inhibit flow from the ride control spool to a control chamber of the low leak check valve.

14. The ride control system of claim 13, wherein the ride control valve includes a control passage coupled to the control chamber of the low leak check valve; and
wherein the control passage is coupled to a port of the low leak check valve via the ride control spool when the ride control spool is in the fourth ride control position.

15. The ride control system of claim 13, wherein the check valve is configured to selectively inhibit flow from the accumulator to the control chamber of the low leak check valve when the ride control spool is in the fourth ride control position.

16. The ride control system of claim 1, wherein the valve body of the ride control valve defines a plurality of passages including a work passage coupled to the work port, a tank passage coupled to the tank port, an accumulator passage coupled to the accumulator, and a pump passage coupled to the pump port.

17. The ride control system of claim 1, wherein a compensator is coupled to the accumulator and the ride control valve, the compensator being configured to sense a valve load-sensing pressure of the ride control system to control a flow rate across the ride control spool.

18. The ride control system of claim 17, wherein the compensator is further configured to maintain a pump margin across the ride control spool and allow the ride control valve to provide compensated warm-up flow within the ride control system.

19. A ride control valve comprising:
a valve body defining a work passage, a pump passage, a tank passage, and an accumulator passage;
a ride control spool movably disposed within the valve body and configured to move between:
a first ride control position that blocks the work passage and the pump passage, and couples the accumulator passage with the tank passage;
a second ride control position that blocks the tank passage and the work passage, and selectively couples the pump passage to the accumulator passage;
a third ride control position that blocks the work passage and selectively couples the accumulator passage with the tank passage; and
a fourth ride control position that blocks the pump passage and the tank passage, and couples the accumulator passage with the work passage; and
a fifth ride control position that blocks the work passage, and couples the accumulator passage with the pump passage and the tank passage; and
a pressure balancing spool movably disposed within the ride control spool, the pressure balancing spool being configured to move relative to the ride control spool to selectively couple the accumulator passage with each of the pump passage and the tank passage.

20. The ride control valve of claim 19, wherein when the ride control spool is in the second ride control position, the pressure balancing spool is configured to move relative to the ride control spool between:
a first balancing position that blocks the work passage and couples the accumulator passage to the pump passage; and
a second balancing position that blocks the pump passage.

21. The ride control valve of claim 20, further including a biasing assembly configured to bias the pressure balancing spool into the first balancing position.

22. The ride control valve of claim 21, wherein the biasing assembly includes a first balancing spring positioned at a first end of the pressure balancing spool to bias the pressure balancing spool into the first balancing position and compresses the first balancing spring when an accumulator passage pressure is less than a charge limit pressure defined by a charge limit relief valve; and
wherein the pressure balancing spool is biased to the second balancing position and compresses the first balancing spring when the accumulator passage pressure is greater than the charge limit pressure.

23. The ride control valve of claim 19, further including a first control spring positioned between the ride control spool and a first spool seat defined by a seat member, a second control spring positioned between the first spool seat and a second spool seat defined by a first end of the valve body, and a third control spring arranged in parallel with the second control spring.

24. The ride control valve of claim 23, wherein, in the first ride control position, the ride control spool is at a first distance from the first spool seat and the seat member is spaced from the second spool seat;
wherein, in the second ride control position, the ride control spool is at a second distance from the first spool seat and the seat member is spaced from the second spool seat;
wherein, in the third ride control position, the ride control spool contacts the first spool seat and the seat member is spaced from the second spool seat; and
wherein, in the fourth ride control position, the ride control spool contacts the first spool seat and the seat member contacts the second spool seat,
wherein, in the fifth ride control position, the ride control spool contacts a third spool seat that is defined by a second end of the valve body opposite the first end.

25. The ride control valve of claim 19, further including a first electrohydraulic pressure regulating valve configured to move the ride control spool from the first ride control position to each of the second ride control position, the third ride control position, and the fourth ride control position.

26. The ride control valve of claim 25, further including a second electrohydraulic pressure regulating valve configured to move the ride control spool from the first ride control position to the fifth ride control position.

27. A method for controlling a ride control valve for a hydraulic machine, the method comprising:
moving a ride control spool of the ride control valve between a plurality of ride control positions to selectively couple a work passage, a pump passage, a tank passage, and an accumulator passage, wherein the plurality of ride control positions includes:
a first ride control position configured to couple the accumulator passage with the tank passage;
a second ride control position configured to selectively couple the pump passage to the accumulator passage, the second ride control position being a variable position between the first ride control position and a third ride control position;
the third ride control position configured to selectively couple the tank passage to the accumulator passage to balance an accumulator pressure of the accumulator passage with a work pressure of the work passage;
a fourth ride control position configured to couple the accumulator passage to the work passage; and
a fifth ride control position configured to couple the accumulator passage with the pump passage and the tank passage.
